(19) United States
(12) Patent Application Publication
(10) Pub. No.: US 2005/0008971 A1
(43) Pub. Date: Jan. 13, 2005

(54) Lithographic printing plate precursor and lithographic printing method

(76) Inventors: Tomoyoshi Mitsumoto, Haibara-gun (JP); Naonori Makino, Haibara-gun (JP)

Correspondence Address: BIRCH STEWART KOLASCH & BIRCH, PO BOX 747, FALLS CHURCH, VA, 22040-0747, US

(21) Appl. No.: 10/885,807

(22) Filed: Jul. 8, 2004

(30) Foreign Application Priority Data
Jul. 10, 2003 (JP) 2003-272909
Jun. 14, 2004 (JP) 2004-175090

(51) Int. Cl. G03C 1/76

(52) U.S. Cl. 430/270.1

(57) ABSTRACT

A lithographic printing plate precursor comprising: a support; an undercoat layer; and an image recording layer containing a polymerization initiator, a polymerizable compound and an infrared ray absorbing agent, the image recording layer being removable with at least one of a printing ink and a fountain solution, in this order, wherein the undercoat layer contains a compound having (a) an ethylenically unsaturated bond and (b) a functional group capable of adsorbing to a surface of the support.

### BACKGROUND OF THE INVENTION

1. Field of the Invention

The present invention concerns a lithographic printing plate precursor and a lithographic printing method using the same. Specifically, it relates to a lithographic printing plate precursor capable of so-called direct print making that can be made-up directly by scanning an infrared laser based on digital signals from a computer or the like as well as a lithographic printing method of developing the lithographic printing plate precursor on a printing press and conducting printing.

2. Description of the Related Art

Generally, a lithographic printing plate comprises an oleophilic image area of receiving an ink and a hydrophilic non-image area receiving fountain solution in the printing process. The lithographic printing is a method of causing a difference in the ink depositability at the surface of a lithographic printing plate using an oleophilic image area as an ink receiving area and a hydrophilic non-image area as a fountain solution receiving area (not ink receiving area) in the lithographic printing plate by utilizing the nature of water and oily ink to repel with each other, depositing an ink only on the image area and then transferring the ink to a matter to be printed such as paper thereby conducting printing.

For preparing a lithographic printing plate, a lithographic printing plate precursor in which an oleophilic photosensitive resin layer (image recording layer) is disposed on a hydrophilic support (PS plate) has been used generally so far. Usually, a lithographic printing plate is obtained by conducting plate making by a method of exposing a lithographic printing plate precursor through an original such as a lith film, then removing the image recording layer at the non-image area by dissolution with an alkaline developer or an organic solvent while leaving an image recording layer in the imaging image area, thereby revealing the surface of the hydrophilic support.

The existent plate making process of a lithographic printing plate precursor requires a step of dissolving to remove the non-image area, for example, by a liquid developer in accordance with the image recording layer and it is one of the subject to save or simplify the additional wet treatment described above. Particularly, since disposal of liquid wastes discharged accompanying the wet treatment has greatly attracted attention through the field of industry in view of the consideration for global environments in recent years, the demand for the solution of the foregoing subject has been increased more and more.

For this purpose, as one of simple and convenient plate making methods, it has been proposed a method so-called as development on printing press of using an image recording layer capable of removing the non-image area in a lithographic printing plate precursor in usual printing process and removing the non-image area after exposure on the printing press thereby obtaining a lithographic printing plate.

Concrete methods for development on printing press can include, for example, a method of using a lithographic printing plate precursor having an image recording layer that can be dissolved or dispersed in fountain solution, an ink solvent or an emulsion of fountain solution and ink, a method of physically removing an image recording layer by contact with an impression cylinder or a blanket cylinder of a printing press, or a method of lowering cohesion of the image recording layer or adhesion between an image recording layer and a support by impregnation of fountain solution, ink solvent or the like and then physically removing the image recording layer by contact with an impression cylinder or a blanket cylinder.

In the invention, unless other wise specified particularly, “development processing step” means a step of using an apparatus other than the printing press (usually automatic developing machine) and removing the non-exposed area of the image recording layer in the lithographic printing plate precursor by contact with liquid (usually alkaline developer) thereby revealing the surface of a hydrophilic support. “Development on printing press” means a method and a process of removing a non-exposed area of an image recording layer the lithographic printing plate precursor by bringing it into contact with a liquid (usually, printing ink and/or fountain solution) by using a printing press thereby exposing the surface of a hydrophilic support.

On the other hand, digitalized technique of electronically processing image information by a computer and accumulating and outputting them has been popularized in recent years, and various new image outputting systems coping with such digitalized technique have been put to practical use. Correspondingly, it has been noted for a computer-to-plate (CTP) technique of carrying digitalized image information on highly converging radiation rays such as a laser light and scanning and exposing a lithographic printing plate precursor with the light thereby directly preparing a lithographic printing plate not by way of a lith type film. Accordingly, it is one of important technical subjects to obtain a lithographic printing plate precursor adaptable to the technique described above.

As has been described above, simplification, introduction of dry process and saving of treatment for print making operation have been demanded strongly more and more than usual both in view of the consideration on the global environment and for adaptation to digitalization.

However, in a case of adopting the existent image recording system of utilizing lights from ultraviolet to visible regions for the simplification of the plate making operation such as development on printing press, since the image recording layer is not fixed even after exposure, it has light sensitivity to room light and the lithographic printing plate precursor has to be kept in a completely light-shielded state after taking out the plate from a package to the completion of the development on printing press.

Recently, since high power laser such as a semiconductor laser emitting an infrared light at a wavelength of 760 to 1200 nm and a YAG laser have become available at a reduced cost, a method of using a high power laser as a image recording light source has been considered prospective as a method of preparing a lithographic printing plate by scanning exposure that can be incorporated easily in the digitalization technique.

In the existent plate making method of utilizing lights from ultraviolet to visible regions, imagewise exposure is conducted to a light sensitive lithographic printing plate precursor at low to medium luminance, and recording is conducted in accordance with the imagewise change of properties due to photochemical reaction in the image recording layer. On the contrary, in the method of using the high power laser described above, a great amount of light energy is irradiated to the exposure region in an extremely short time to efficiently convert the light energy into the heat energy thereby causing thermal change such as chemical change, phase change, or change of the form or structure in the image recording layer by the heat, and the change is utilized for image recording. Accordingly, while image information is inputted by the light energy such as of a laser light, image recording is conducted under the state of adding the reaction due to the heat energy in addition to the light energy. Usually, the recording system of utilizing the heat generation by the exposure at high power density is referred to as heat mode recording and conversion of light energy into heat energy is referred to as photothermal conversion.

A major advantage of the plate making method using the heat mode recording is that the image recording layer is not sensitized by a light at a usual luminance level such as in room illumination and that fixing of images recorded by exposure at high luminance is not essential. That is, the lithographic printing plate precursor used for the heat mode recording has no worry of being sensitized by room light before exposure and fixing of images is not essential after exposure. Accordingly, for example, in a case of using an image recording layer which is insolubilized or solubilized by exposure using high power laser and conducting a plate making process of making the exposed image recording layer imagewise to prepare the lithographic printing plate by development on printing press, it has been expected to achieve a printing system in which images are free from the effect even when exposed, for example, to circumstantial light in a room after exposure and implementation thereof has been demanded.

For example, as a lithographic printing plate precursor, a lithographic printing plate precursor of disposing, on a hydrophilic support, an image forming layer in which hydrophobic thermoplastic polymer particles are dispersed in a hydrophilic binder has been known (for example, refer to JP No. 2938397 specification). The lithographic printing plate precursor described above can be developed on printing press by exposure of an infrared laser to agglomerate the hydrophobic thermoplastic polymer particles by heat thereby forming images, then loaded on the cylinder of a printing press, and by supplying fountain solution and/or ink.

However, while the method of forming images by mere agglomeration of fine particles with thermal diffusion show good developability on printing press, the strength of images was extremely weak and printing durability was insufficient.

Further, it has been known that a lithographic printing plate precursor having an image recording layer containing polymerizable compound-incorporated microcapsules can be developed on printing press (refer to JP-A No. 2001-277740 and JP-A No. 2001-277742).

Further, a lithographic printing plate precursor developable on printing press in which a light sensitive layer containing an infrared ray absorbing agent, a radical polymerization initiator and a polymerizable compound on a support has been known (refer to JP-A No. 2002-287334).

While the method of using the polymerizing reaction described above has improved the strength of images since the chemical bonding density in the image area is higher compared with that in the image area formed by thermal fusion of fine polymer particles, a further improvement has been necessary for compatibility between the developability on printing press and contamination durability in printing and high printing durability.

In order to solve the problem, it has been proposed to incorporate a compound having an ethylene oxide chain in the image forming layer (image recording layer) (refer to JP-A No. 2002-365789). However, even the technique is still insufficient in view of the compatibility between the developability on printing press and the contamination durability and high printing durability.

On the other hand, in the field of photopolymerizable printing plates, it has been known to provide an intermediate layer containing a compound having a polymerizable group and a support adsorbing group between a support and a photopolymerizable layer for improving the adhesion. However, any of the techniques known so far involves a problem of worsening the contamination durability in the non-image area when the adhesion is increased.

For example, JP-A No. 7-159983 discloses a sol-gel intermediate layer between a support and a photopolymerization layer and JP-A No. 9-269593 discloses a sol-gel intermediate layer with addition of a phenolic compound or a phosphate compound. However, a liquid developer containing silicate has been used exclusively in any of them in order to improve the hydrophilicity by coupling a silicate to the non-image area upon development. Further, as another example, an organic phosphate type compound is used as an intermediate layer in JP-A No. 2000-235254 but it is described that the phosphono group as an acidic group splits rapidly in the course of alkali development to lose interaction with the support and/or provide hydrophilicity. As can be seen from the examples described above, it was a common knowledge in the relevant art that alkali development is indispensable for the adhesive intermediate layer.

### SUMMARY OF THE INVENTION

The present invention has been accomplished with a view point that a further improvement is necessary for the compatibility between the developability on printing press and contamination durability, and high printing durability in the prior art and intends to provide a lithographic printing plate precursor capable of making the developability on printing press and contamination durability, and high printing durability, as well as a lithographic printing plate printing method using the same.

The present inventors have accomplished the foregoing subject by a devising a composition for an undercoat layer between a support and an image recording layer.

That is, the constitution of the invention is as described below.

(1) A lithographic printing plate precursor comprising: a support; an undercoat layer; and an image recording layer containing a polymerization initiator, a polymerizable compound and an infrared ray absorbing agent, the image recording layer being removable with at least one of a printing ink and a fountain solution, in this order, wherein the undercoat layer contains a compound having (a) an ethylenically unsaturated bond and (b) a functional group capable of adsorbing to a surface of the support.

(2) A lithographic printing plate precursor comprising: a support; an undercoat layer; and an image recording layer containing a polymerization initiator, a polymerizable compound and an infrared ray absorbing agent, the image recording layer being removable with at least one of a printing ink and a fountain solution, in this order, wherein the undercoat layer contains a compound having (a) an ethylenically unsaturated bond and (b) a hydrophilic group.

(3) A lithographic printing plate precursor as described in (1) above, wherein the compound having (a) the ethylenically unsaturated bond and (b) the functional group capable of adsorbing to the surface of the support further has a hydrophilic group in its molecule.

(4) A lithographic printing plate precursor as described in (1) or (3) above, wherein the compound having (a) the ethylenically unsaturated bond and (b) the functional group capable of adsorbing to the surface of the support is represented by the formula (I): 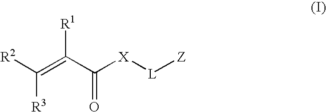
[in which R¹, R² and R³ each represents independently a hydrogen atom, halogen atom, or an alkyl group of 1 to 6 carbon atoms: X represents an oxygen atom or imino; L represents a bivalent connection group; and Z represents a functional group capable of adsorbing to the surface of the support].

(5) A lithographic printing plate precursor as described in (4) above, wherein L in the formula (I) represents a bivalent connection group containing plural polyoxyalkylene structures.

(6) A lithographic printing plate precursor as described in (1) or (3) above, wherein the support is an aluminum support subjected to a silicate treatment and the functional group capable of adsorbing to the surface of the support is an acid group.

(7) A lithographic printing plate precursor as described in any one of (1) to (6), wherein at least one of the infrared ray absorbing agent, the polymerization initiator and the polymerizable compound is microencapsulated.

(8) A lithographic printing method comprising: loading a lithographic printing plate precursor according to claim 1 to a printing press; imagewise exposing the lithographic printing plate precursor with a laser; and supplying a printing ink and fountain solution to the lithographic printing plate precursor so as to remove a not-exposed area in the image recording layer by at least one of a printing ink and a fountain solution; and printing.

(9) A lithographic printing method as described in (8) above, wherein the loading is performed before the imagewise exposing.

(10) A lithographic printing method as described in (8) above, wherein the loading is performed after the imagewise exposing.

It is noted that the loading of the lithographic printing plate precursor to the printing press may be performed either before or after the imagewise exposing of the lithographic printing plate precursor.

### DETAILED DESCRIPTION OF THE INVENTION

The present invention is to be described specifically.

A lithographic printing plate precursor according to the invention has a feature in a lithographic printing plate precursor having, on a support, an undercoat layer and an image recording layer containing a polymerization initiator, a polymerizable compound and an infrared ray absorbing agent and removable with at least one of a printing ink and a fountain solution in this order in which the undercoat layer contains a compounds having an ethylenically unsaturated bond and a functional group capable of adsorbing to the surface of the support. Each of constituent elements of the lithographic printing plate precursor according to the invention is to be described.

[Undercoat Layer]

The undercoat layer in the first embodiment of the invention contains a compound having an ethylenically unsaturated bond and a functional group capable of adsorbing to the surface of the support (adsorbing group). The compound preferably has a hydrophilic group in the molecule. Further, the undercoat layer in the second embodiment of the invention contains a compound having an ethylenically unsaturated bond and a hydrophilic group.

Whether adsorptivity to the surface of the support is present or not can be judged, for example, by the following method. A test compound is dissolved in an easily soluble solvent to prepare a coating solution, and the coating solution is coated and dried on a support such that the coating amount after drying is 30 mg/m². After thoroughly washing the support coated with the test compound by using an easily soluble solvent, the residual amount of the test compound that was not removed by washing was measured to calculate the adsorption amount on the support. For measuring the residual amount, the residual amount of the compound may be determined directly, or may be calculated by determining the amount of the test compound dissolved in the washing solution. The determination for the compound can be practiced, for example, by fluorescent X-ray spectrometry, reflection absorption spectrometry or liquid chromatography. The compound having the adsorptivity to support is a compound that remains by 1 mg/m² or more even after conducting the washing treatment as described above.

The adsorbing group to the surface of the support is a functional group capable of taking place chemical bonding (for example, ionic bonding, hydrogen bonding, coordination bonding and bonding by inter molecular force) with a substance present on the surface of the support (for example, metal, metal oxide) or functional group (for example, hydroxyl group). The adsorbing group is preferably an acid group or a cationic group.

The acid group preferably has a acid dissociation constant (pKa) of 7 or less. Example of the acid group can include phenolic hydroxyl group, carboxyl group, —SO₃H, —OSO₃H, —PO₃H₂, —OPO₃H₂, —CONHSO₂—, —SO₂NHSP₂ and —COCH₂COCH₃. Among them, phosphate group (—OPO₃H₂, —PO₃H₂) is particularly preferred.

The cationic group is preferably an onium group. Example of the onium group can include, for example, ammonium group, phosphonium group, arsonium group, stibonium group, oxonium group, sulfonium group, selenonium group, stannonium group, and iodonium group. Among them, ammonium group, phosphonium group and sulfonium group are preferred, ammonium group and phosphonium group are further preferred, and ammonium group is most preferred.

Example of the functional groups capable of adsorbing to the surface of the support are to be shown below.

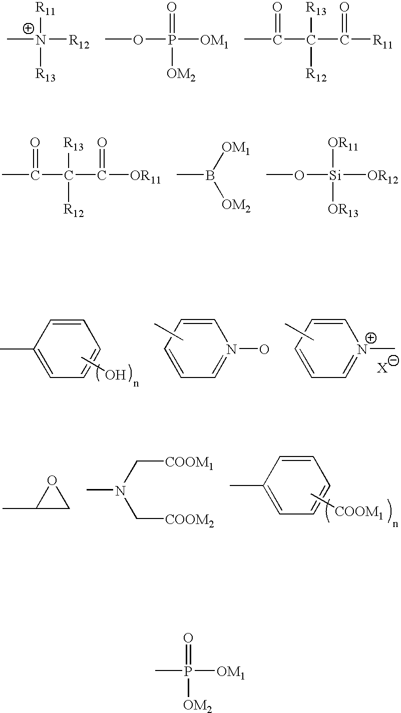

In the formula R₁₁ to R₁₃ each independently represents a hydrogen atom, an alkyl group, aryl group, alkinyl group or alkenyl group. M₁ and M₂ each independently represents a hydrogen atom, metal atom or an ammonium group. X⁻ represents a counter anion.

As an adsorbing group, an onium group (for example, ammonium group or pyridium group), phosphate ester group, borate group, β-diketone group (for example, acetylacetone group) are particularly preferred.

In the invention, the compound having an ethylenically unsaturated bond and an adsorbing group to the surface of a support is preferably represented by the following formula (I).
(I)

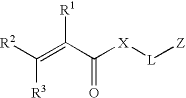

In the formula (I), R¹, R² and R³ each independently represents a hydrogen atom, halogen atom or an alkyl group of from 1 to 6 carbon atoms, R¹ and R² and R³ each independently represents, preferably, a hydrogen atom or an alkyl group of from 1 to 6 carbon atoms, more preferably, a hydrogen atom or an alkyl group of from 1 to 3 carbon atoms and, most preferably, a hydrogen atom or methyl. It is particularly preferred that R² and R³ each represents a hydrogen atom.

In the formula (I), X represents an oxygen atom (—O— or imino (—NH—). More preferably, X represents an oxygen atom.

In the formula (I), L represents a bivalent connection group. It is preferred that L represents a bivalent aliphatic group (alkylene group, substituted alkylene group, alkenylene group, substituted alkenylene group, alkinylene group, or substituted alkinylene group), a bivalent aromatic group (arylene group, or substituted arylene group) or a bivalent heterocyclic group or a combination of the group described above with an oxygen atom (—O—), sulfur atom (—S—), imino (—NH—), substituted imino (—NR—, where R represents an aliphatic group, aromatic group or heterocyclic group), or carbonyl (—CO—).

The aliphatic group may have a cyclic structure or a branched structure. The number of carbon atoms of the aliphatic group is, preferably, from 1 to 20, more preferably, from 1 to 15, and most preferably, from 1 to 10. It is preferred that the aliphatic group is a saturated aliphatic group rather than an unsaturated aliphatic group. The aliphatic group may have a substituent. Examples of the substituent can include a halogen atom, hydroxyl, aromatic group and heterocyclic group.

The number of carbon atoms of the aromatic group is, preferably, from 6 to 20, more preferably, from 6 to 15 and most preferably, from 6 to 10. The aromatic group may have a substituent. Examples of the substituent can include a halogen atom, a hydroxyl, aliphatic group, aromatic group, and heterocyclic group.

It is preferred that the heterocyclic group has a five-membered or six-membered ring as a hetero ring. Other heterocyclic ring, aliphatic group or aromatic ring may be condensed to the heterocyclic ring. The heterocyclic group may have a substituent. Examples of the substituent can include a halogen atom, a hydroxyl, oxo (═O), thio (═S), imino (═NH), substituted imino group (═N—R where R represents an aliphatic group, aromatic group or heterocyclic group), aliphatic group, aromatic group and heterocyclic group.

It is preferred that L represents a bivalent connection group containing a plurality of polyoxyalkylene structures. It is more preferred that the polyoxyalkylene structure is a polyoxyethylene structure. That is, it is preferred that L contains —(OCH₂CH₂)ₙ— (n is an integer of 2 or greater).

In the formula (I), Z represents a functional group capable of adsorbing to the surface of the support. The adsorptive functional group is as has been described above.

The hydrophilic group which can be contained in the compound of the invention includes, an ethylene oxide group (—(OCH₂CH₂)ₙ—), where n represents, preferably, from 1 to 50, more preferably, from 1 to 20.

The molecular weight of the compound of the invention is, preferably, 10,000 or less and, more preferably, 2,000 or less.

The specific examples of the compound of the invention can include the following commercial products, but the invention is not restricted only thereto.
[A] CH₂═C(CH₃)COO(C₂H₄O)ₙP═O(OH)₂, n=1, Uni-Chemical Co. Ltd.; PHOSMER M, Nippon Kayaku Co. Ltd.; KAYAMER-PM-1, Kyoeisha Yushi Co. Ltd.; LIGHT ESTER P-M, Shin-Nakamura Chemical Co. Ltd.; NK ESTER SA, n=2; Uni-Chemical Co. Ltd.; PHOSMER PE2, n=4 to 5; Uni-Chemical Co. Ltd.; PHOSMER PE, n=8; Uni Chemical Co. Ltd.; PHOSMER PE8,
[B] [CH₂═C(CH₃)COO(C₂H₄O)ₙ] P═O(OH)₃₋ₘ: a mixture where n=1 and m=1 and 2; Daihachi Chemical Co. Ltd.; MR-200,
[C] CH₂═CHCOO(C₂H₄O)ₙP═O(OH)₂, n=1; Uni Chemical Co Ltd.; PHOSMER A, Kyoeisha Yushi Co. Ltd.; LIGHT ESTER P-A,
[D] [CH₂═CHCOO(C₂H₄O)ₙ]ₘP═O(OH)₃₋ₘ: a mixture where n=1, and m=1 and 2; Daihachi Chemical Co. Ltd. AR-200,
[E] CH₂═C(CH₃)COO(C₂H₄O)ₙP═O(OC₄H₉)₂, n=1; Daihachi Chemical Co. Ltd.; MR-204,
[F] CH₂═CHCOO(C₂H₄O)ₙP═O(OC₄H₉)₂, n=1; Daihachi Chemical Co. Ltd.; AR-204,
[G] CH₂═C(CH₃)COO(C₂H₄O)ₙP═O(OC₈H₁₇)₂, n=1; Daihachi Chemical Co. Ltd.; MR-208,
[H] CH₂═CHCOO(C₂H₄O)ₙP═O(OC₈H₁₇)₂, n=1; Daihachi Chemical Co. Ltd.; AR-208,
[I] CH₂═C(CH₃)COO(C₂H₄O)P═O(OH) (ONH₃C₂H₄OH), n=1; Uni-Chemical Co. Ltd.; PHOSMER MH,
[J] CH₂═C(CH₃)COO(C₂H₄O)ₙP═O(OH) (ONH(CH₃)₂C₂H₄OCOC(CH₃)═CH₂); n=1; Uni-Chemical Co. Ltd.; PHOSMER DM,
[K] CH₂═C(CH₃)COO(C₂H₄O)ₙP═O(OH) (ONH(C₂H₁₅)₂C₂H₄OCOC(CH₃)═CH₂); n=1; Uni-Chemical Co. Ltd.; PHOSMER DE,
[L] CH₂═CHCOO(C₂H₄O)ₙP═O(O—ph)₂ (ph represents a benzene ring), n=1; Daihachi Chemical Co; AR-260,
[M] CH₂═C(CH₃) COO(C₂H₄O)P═O(O—ph)₂, n=1; Daihachi Chemical Co. Ltd.; MR-260,
[Q] [CH₂═CHCOO(C₂H₄O)ₙ]₂P═O(OC₄H₉), n=1; Daihachi Chemical Co.; PS-A4,
[N] [CH₂═C(CH₃) COO(C₂H₄O) n]2P═O(OH), n=1; Daihachi Chemical Co. Ltd.; MR-200, Nippon Kayaku Co. Ltd.; KAYAMER PM-2, Nippon Kayaku Co. Ltd.; KAYAMER-PM-21,
[O] [CH₂═CHCOO(C₂H₄O)ₙ]₃P═O, n=1; Ohsaka Yuki Co. Ltd.; BISCOAT 3PA.

Those compounds can be synthesized, in the same manner as ordinary acrylic monomers, by dehydrating reaction or ester exchange from acrylic acid or methacrylic acid and a phosphoric acid compound as described in “Experimental Chemistry Course” and “UV-ray Curing system” written by Kiyomi Kato et. al. Further, the phosphoric compound may be prepared for use by mixing several compounds at an optional ratio. Referring to the number of chain n of the ethylene oxide in the formula, as the number is greater in view of synthesis, synthesis of pure products is more difficult, to result in a mixture of those having approximate numbers. Specifically, the number is: n=0, 1, 2, about 4 to 5, about 5 to 6, about 7 to 9, about 14, about 23, about 40, about 50, but not restricted to them.

In addition, the following compounds can also be mentioned preferably as compounds having an ethylenically unsaturated bond and a functional group capable of adsorbing to the surface of support according to the invention.

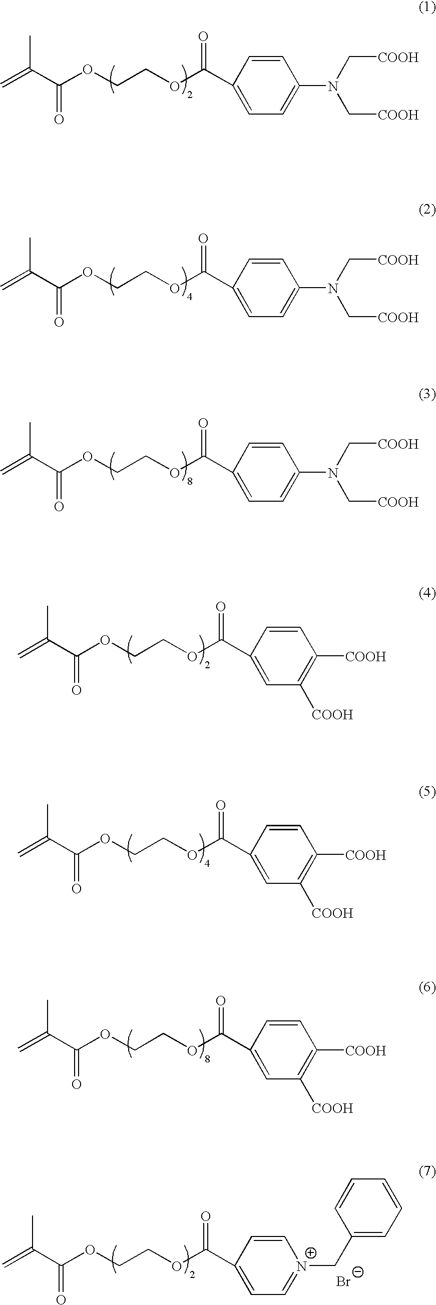

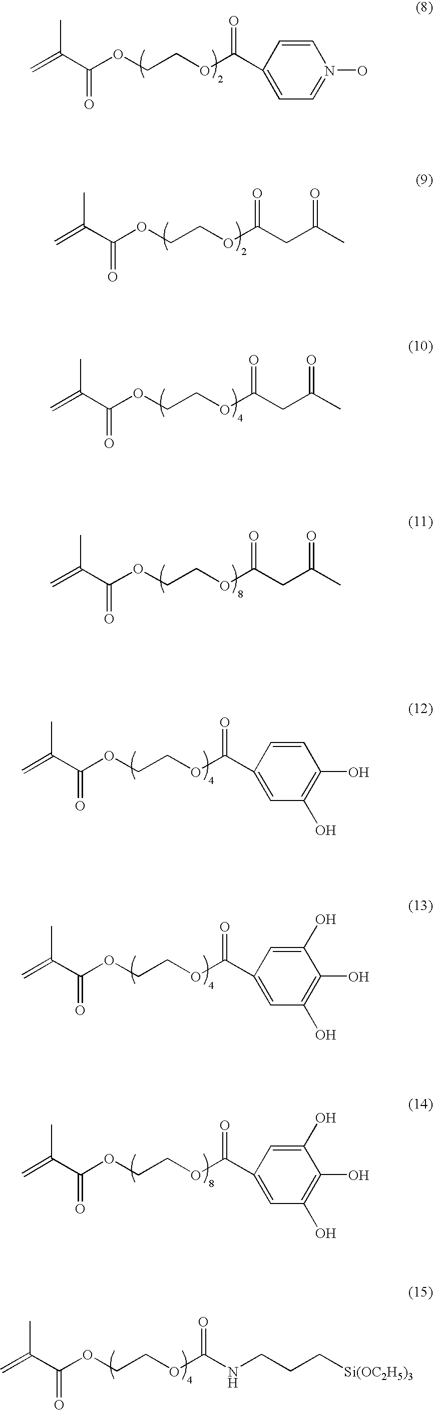

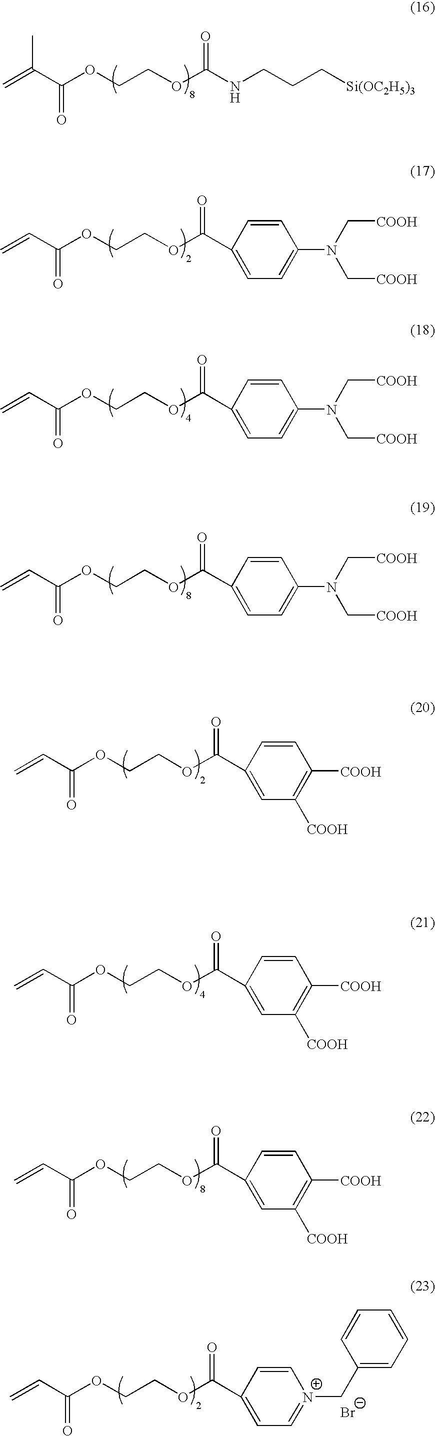

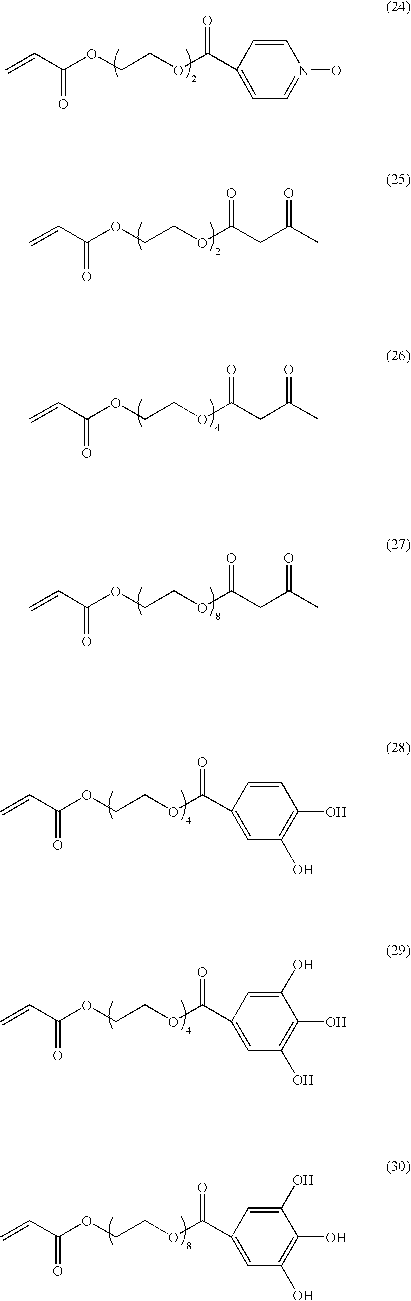

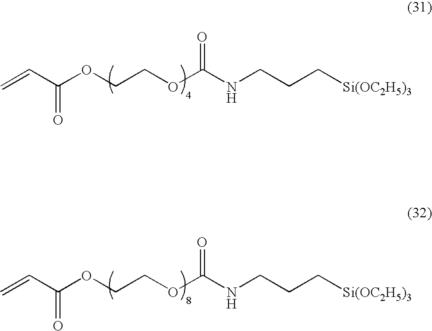

A plurality species of these compounds may be used in admixture at an optional ratio. The undercoat layer can be formed by a method of coating a solution of the compound dissolved in water, or in an organic solvent such as methanol, ethanol or, methyl ethyl ketone or mixed solvents thereof on a surface-treated aluminum support, followed by drying, or a method of immersing a surface-treated aluminum support in a solution of the compound dissolved in water, or in an organic solvent such as methanol, ethanol, methyl ethyl ketone or mixed solvents thereof to let the compound to be adsorbed, and then rinsing with water etc. followed by drying. In the former method, a solution of the compound at a concentration of from 0.005 to 10 mass % can be coated by various methods. Any method such as bar coater application, spin-coating, spray coating, curtain coating can be adopted. Further, in the latter method, the concentration of the solution is from 0.01 to 20 mass %, preferably, from 0.05 to 5 mass %, and the dipping temperature is from 20 to 90° C., preferably, from 25 to 50° C. The dipping time is from 0.1 sec to 20 min, preferably, from 2 sec to 1 min. The coating amount of the undercoat layer after drying is, preferably, from 0.1 to 100 mg/m² and, more preferably, from 1 to 30 mg/m².

[Image Recording Layer]

The image recording layer of a lithographic printing plate precursor of the invention contains (A) an infrared-ray absorbing agent, (B) a polymerization initiator and (C) a polymerable compound, and can be removed by at least one of a printing ink and a fountain solution. Then, each of constituent ingredients of the image recording layer will be described below.

((A) Infrared Ray Absorbing Dye)

In the image recording layer of the invention, an infrared ray absorbing dye is contained to achieve efficient image formation using a laser emitting infrared rays of from 760 to 1200 nm as a light source. An infrared ray absorbing dye has an effect of converting absorbed infrared rays to heat. The generated heat thermally decomposes a polymerization initiator (radical generator) to be described later to generate radicals. The infrared ray absorbing dye to be used in the invention is a dye or pigment having an absorption maximum at a wavelength of from 760 to 1200 nm.

As the dye, commercially available dyes and known dyes, for example, described in literatures such as “Dye Manual” (edited by Organic Synthesis Chemical Society, published in 1970) can be used. They can include, specifically, azo dyes, metal complex salt azo dyes, pyrazolon azo dyes, naphthoquinone dyes, anthraquinone dyes, phthalocyanine dyes, carbonium dyes, quinoneimine dyes, methine dies, cyanine dyes, squarylium dyes, pyrylium salt, metal thilate complex, etc.

Preferable example of the dyes can include cyanine dyes described in JP-A Nos. 58-125246, 59-84356 and 60-78787, methine dyes described in JP-A Nos. 58-173696, 58-181690, 58-194595, etc., naphthoquinone dyes described in JP-A Nos. 58-112793, 58-224793, 59-48187, 59-73996, 60-52940, 60-63744, etc., a squarylium dye described in JP-A No. 58-112792 and a cyanine dye described in the specification of BP No. 434,875.

In addition, a near infrared ray absorption sensitizer described in the specification of U.S. Pat. No. 5,156,938 is preferably used and, in addition, a substituted arylbenzo(thio)pyrylium salt described in the specification of U.S. Pat. No. 3,881,924, a trimethine thiapyrylium salt described in JP-A No. 57-142645 (specification of U.S. Pat. No. 4,327,169), pyrylium type compounds described in each of JP-A Nos. 58-181051, 58-220143, 59-41363, 59-84248, 59-84249, 59-146063 and 59-146061, a cyanine dye described in JP-A No. 59-216146, a pentamethine thiopyrylium salt described in the specification of U.S. Pat. No. 4,283,475, and pyrylium compounds disclosed in JP-B Nos. 5-13514 and 5-19702 are used preferably. In addition, another preferred example of the dye can include a near infrared ray absorbing dye described in formulae (I) and (II) in the description of U.S. Pat. No. 4,756,993.

Further, other preferred examples of the infrared ray absorbing dyes of the invention can include a specified indolenine cyanine dye described in JP-A No. 2002-278057.

Among the dyes, particularly preferred are cyanine dye, squaryllium dye, pyrilium salt, nickel thiolate complex, and indolenine cyanine dye. Further, the cyanine dye and the indolenine cyanine die are preferred, and a cyanine dye represented by the following general formula (i) is mentioned as one of particularly preferred examples.
General Formula (i)

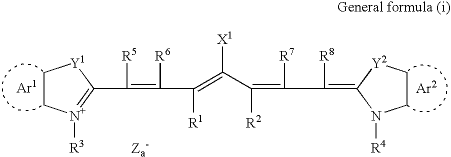

In the general formula (i), X¹ represents a hydrogen atom, halogen atom, —NPh₂, X²—L¹ or a group shown below: 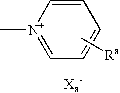
in which X² represents an oxygen atom, nitrogen atom or sulfur atom, L¹ represents a hydrocarbon group of from 1 to 12 carbon atoms, an aromatic ring having a hetero atom or a hydrocarbon group of from 1 to 12 carbon atoms containing a hetero atom. The hetero atom indicates herein N, S, O, a halogen atom or Se. Xa⁻ is defined in the same manner as Za⁻ to be defined later, and R^{a} represents a substituent selected from a hydrogen atom, an alkyl group, aryl group, substituted or unsubstituted amino group and a halogen atom.

R¹ and R² each independently represents a hydrocarbon group of from 1 to 12 carbon atoms. In view of the store stability of the recording layer coating solution, it is preferred that R¹ and R² each represents a hydrocarbon group of two or more carbon atoms, and particularly preferably, R¹ and R² join to each other to form a five-membered or six-membered ring.

Ar¹ and Ar² may be identical with or different from each other, and each represents an aromatic hydrocarbon group which may have a substituent. Preferred examples of the aromatic hydrocarbon group can include a benzene ring and a naphthalene ring. Further, preferred examples of the substituent can include a hydrocarbon group of 12 or less carbon atoms, a halogen atom, and an alkoxy group of 12 or less carbon atoms. Y¹ and Y² may be identical with or different from each other, and each represents a sulfur atom or a dialkylmethylene group of 12 or more carbon atoms. R³ and R⁴ may be identical with or different from each other, and each represents a hydrocarbon group of 20 or less carbon atoms which may have a substituent. Preferred examples of the substituent can include an alkoxy group of 12 or less carbon atoms, carboxyl group and sulfo group. R⁵, R⁶, R⁷ and R⁸ may be identical with or different from each other, and each represents a hydrogen atom or a hydrocarbon group of 12 or less carbon atoms. In view of availability of materials, a hydrogen atom is preferred. Further, Za⁻ represents a counter anion. However, Za⁻ is not necessary when the cyanine dye represented by the general formula (i) has an anionic substituent in the structure, and neutralization of charges is not necessary. Preferred examples of Za⁻ can include a halogen ion, perchlorate ion, tetrafluoroborate ion, hexafluorophosphate ion and sulfonate ion, and particularly preferred examples can include perchlorate ion, hexafluorophosphate ion and arylsulfonate ion in view of the store stability of the recording layer coating solution.

Specific examples of the cyanine dye represented by the general formula (i) which can be used suitably in the invention can include those described in the columns Nos. [0017] to [0019] in JP-A No. 2001-133969.

Further, particularly preferred examples can include a specified indolenine cyanine dye described in JP-A No. 2002-278057.

As the pigments to be used in the present invention, commercially available pigments and pigments described in Color Index (C.I.) Manual, “Modern Pigment Manual” (edited by Nippon Pigment Technology Society, published in 1977), “Modern Pigment Application Technology” (published from CMC, in 1986), “Printing Ink Technology” (published from CMC, in 1984) can be utilized.

As the kinds of pigments, black pigments, yellow pigments, orange pigments, brown pigments, red pigments, violet pigments, blue pigments, green pigments, fluorescent pigments, metal powder pigments and, in addition, polymer bonded dyes are mentioned. Specifically, insoluble azo pigments, azolake pigments, condensed azo pigments, chelate azo pigments, phthalocyanine pigments, anthraquinone pigments, perylene and perynone pigments, thioindigo pigments, quinacrydone pigments, dioxadine pigments, isoindolinone pigments, quinophthalone pigments, dyed lake pigments, azine pigments, nitroso pigments, nitro pigments, natural pigments, fluorescent pigments, inorganic pigments and carbon black etc. can be used. Among them, preferred are a carbon black.

The pigments described above can be used with or without application of a surface treatment. The method of surface treatment can include, for example, a method of surface-coating with a resin or wax, a method of depositing a surfactant, a method of bonding a reactive substance (for example, silane coupling agent, epoxy compound or polyisocyanate etc.) on the surface of the pigment. The method of surface treatment is described in “Properties and Application of Metal Soap” (published from Miyuki-Shobo), “Printing Ink Technology” (published from CMC, in 1984), and “Modern Pigment Application Technology” (published from CMC, in 1986).

The grain size of the pigment is, preferably, within a range from 0.01 μm to 10 μm, further preferably, within a range from 0.05 μm to 1 μm, particularly preferably, within a range from 0.1 to 1 μm. Satisfactory stability of the pigment dispersion in the image recording layer coating solution and satisfactory uniformity of the image recording layer can be obtained within the range described above.

As a method of dispersing the pigment, known dispersing techniques to be used for manufacture of inks, toners etc., can be used. Examples of a dispersing machine can include supersonic disperser, sand mill, attritor, pearl mill, super mill, ball mill, impeller, disperser, KD mill, colloid mill, dynatron, 3-roll mill and pressing kneader, etc. Details are described in “Modern Pigment Application Technology” (published from CMC in 1986).

The infrared ray absorbing dye is contained, in the image recording layer, in a range of from 1 to 5 mass % based on the total solid content of the image recording layer. It is contained, more preferably, within a range of from 1 to 4 mass % and, particularly preferably, within a range from 1 to 3 mass % based on the total solid content. Good sensitivity can be obtained within the range.

((B) Polymerization Initiator)

The polymerization initiator which can be used in the invention generates radicals by the energy of heat, light or both of them, and initiates and proceeds the curing reaction of the polymerable compounds to be described later. As a polymerization initiator for this purpose, thermal decomposition-type radical generators which generate radicals by thermal decomposition are useful. When the radical generator is used in combination with the infrared ray absorbing agent described above, the infrared absorber generates heat upon irradiation of infrared laser and the radical generator generates radicals by the heat, so that heat mode recording is possible by the combined use of them.

Examples of the radical generator can include onium salts, triazine compound having a trihalomethyl group, peroxide, azo type polymerization initiator, azide compound and quinone diazide, etc. The onium salt is preferred owing to its high sensitivity. The onium salt which can be used suitably as the radical polymerization initiator in the invention will be described below. Preferred examples of the onium salt can include iodonium salt, diazonium salt, and sulfonium salt. In the invention, such onium salts function not as an acid generator, but as an initiator for radical polymerization. Especially preferred examples of the onium salt to be used in the invention can include onium salts represented by the following general formulas (I) to (III):
Ar¹¹—I^{+—Ar}¹² Z¹¹⁻ General formula (I)

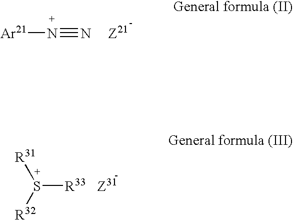

In the formula (I), Ar¹¹ and Ar¹² each independently represents an aryl group of 20 or less carbon atoms, which may have a substituent. In a case where the aryl group has a substituent, preferred examples of the substituent can include a halogen atom, a nitro group, an alkyl group of 12 or less carbon atoms, alkoxy group of 12 or less carbon atoms, or aryloxy group of 12 or less carbon atoms. Z¹¹⁻ represents a counter ion selected from the group consisting of halogen ion, perchlorate ion, tetrafluoroborate ion, hexafluorophosphate ion, carboxylate ion and sulfonate ion, preferably, perchlorate ion, hexafluorophosphate ion, carboxylate ion and arylsulfonate ion.

In the formula (II), Ar²¹ represents an aryl group of 20 or less carbon atoms, which may have a substituent. Preferred example of the substituent can include a halogen atom, a nitro group, an alkyl group of 12 or less carbon atoms, alkoxy group of 12 or less carbon atoms, aryloxy group of 12 or less carbon atoms, alkylamino group of 12 or less carbon atoms, dialkylimino group of 12 or less carbon atoms, arylamino group of 12 or less carbon atoms and diarylamino group of 12 or less carbon atoms. Z²¹⁻represents the same counter ion as defined for Z¹¹⁻.

In the formula (III), R³¹, R³² and R³³ may be identical with or different from each other, and each represents a hydrocarbon group of 20 or less carbon atoms which may have a substituent. Preferred examples of the substituent can include a halogen atom, nitro group, alkyl group of 12 or less carbon atoms, alkoxy group of 12 or less carbon atoms, or aryloxy group of 12 or less carbon atoms. Z³¹⁻ represents the same counter ion as defined for z¹¹⁻.

In the invention, specific examples of the onium salt preferably used as the radical initiator can include those described in JP-A Nos. 2001-133969, 2001-343742, and 2002-148790. Onium salts ([OI-1] to [OI-10]) represented by the general formula (I), onium salts ([ON-1] to [ON-5]) represented by the general formula (II), and onium salts ([OS-1] to [OS-10]) represented by the general formula (III) preferably used, in the invention are described above, with no restriction to them.

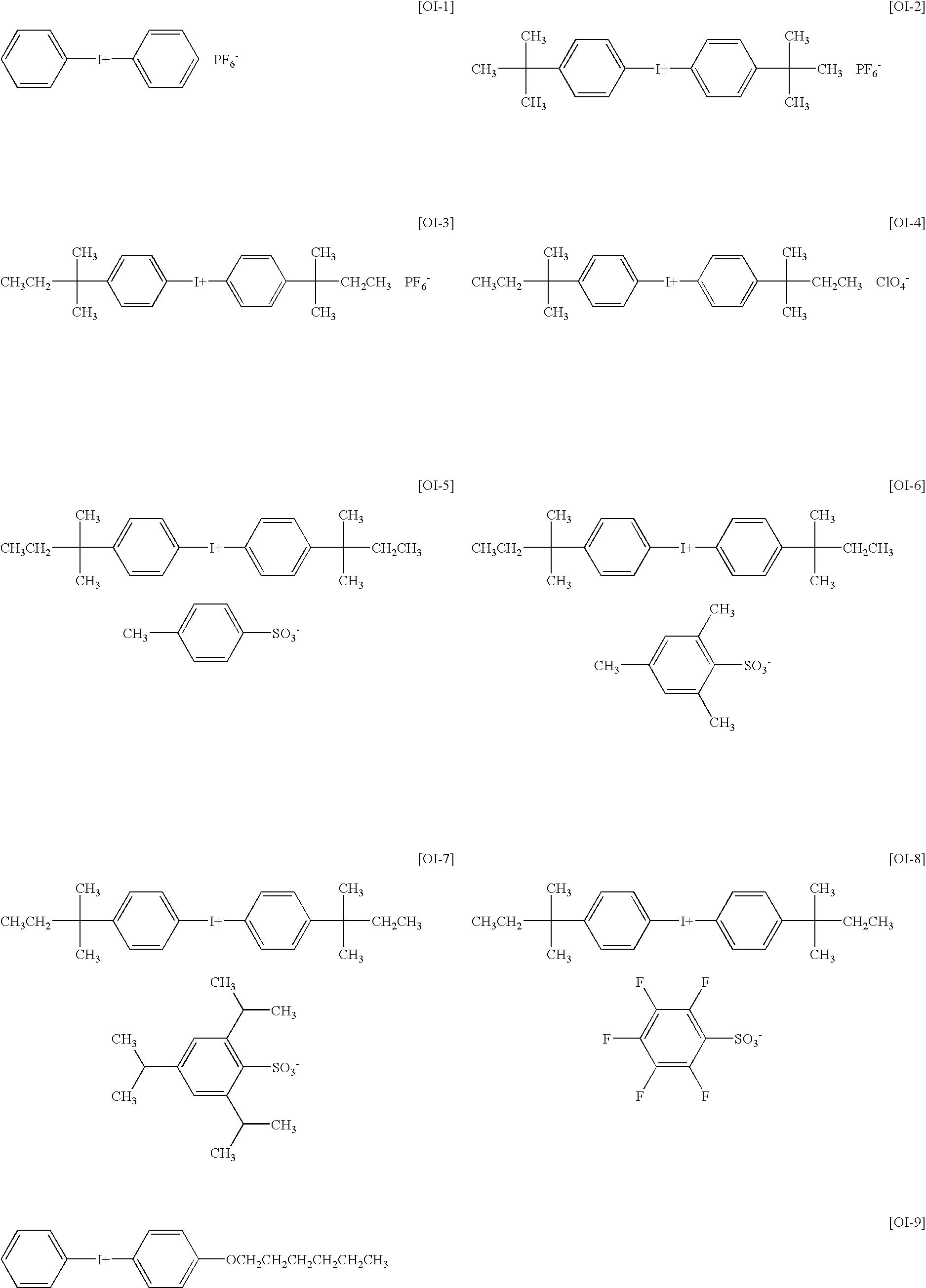

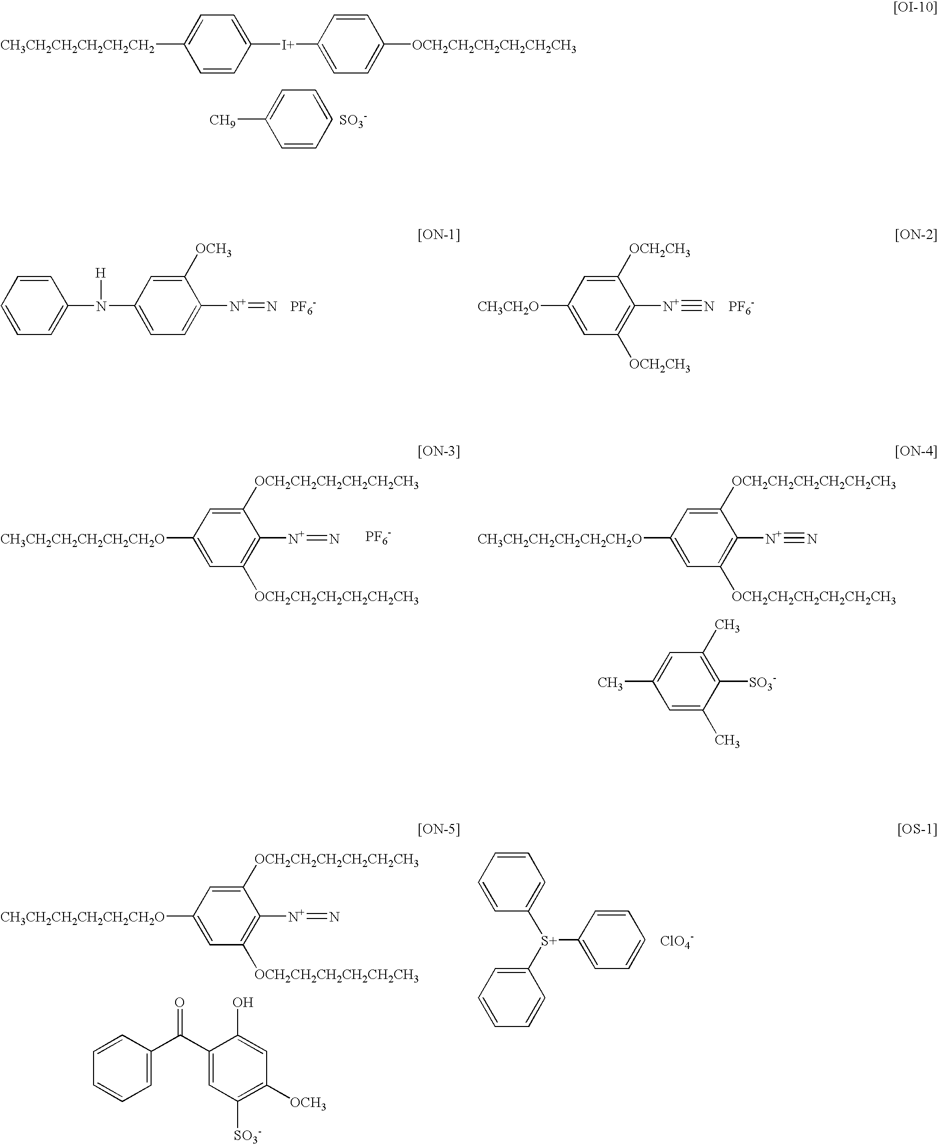

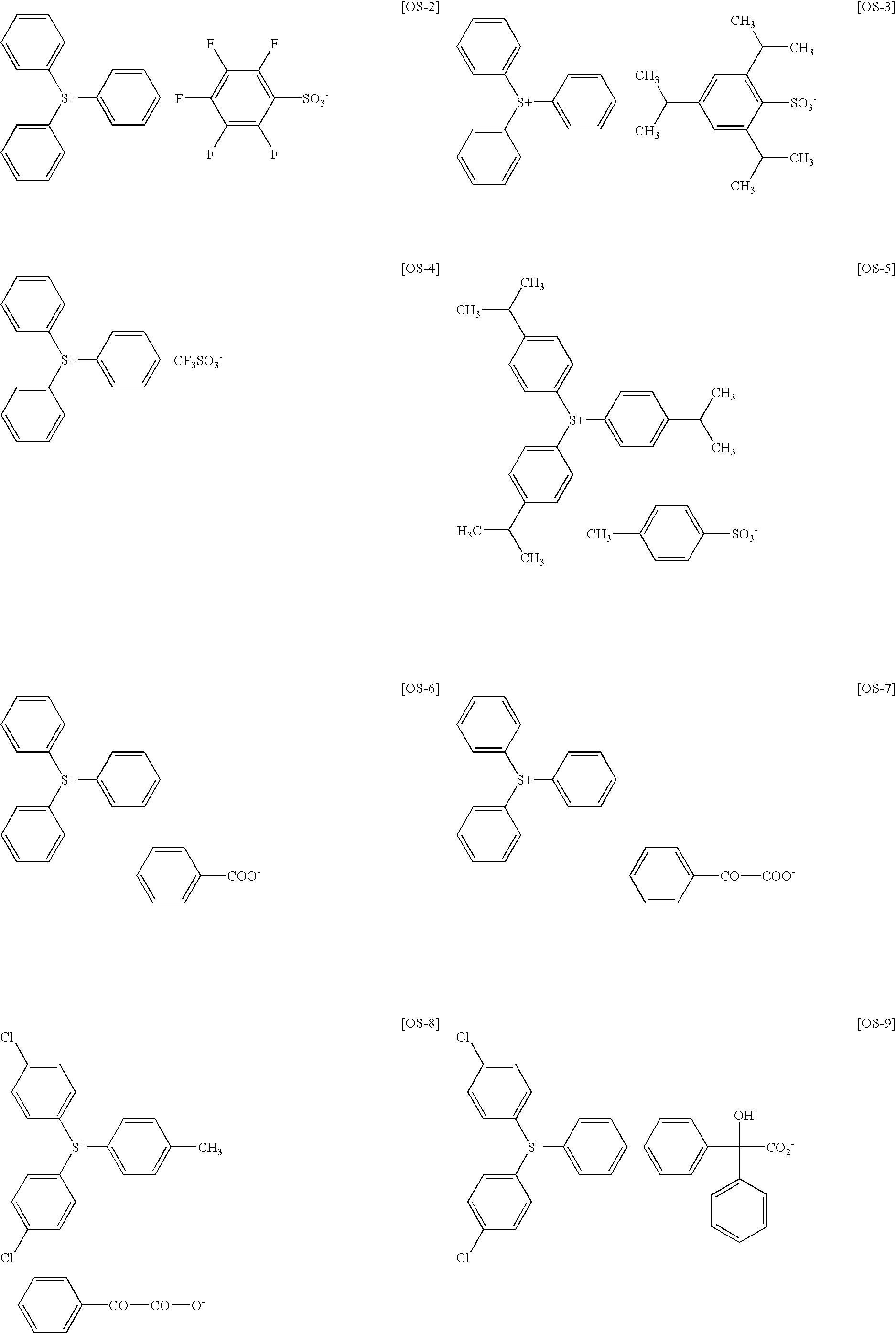

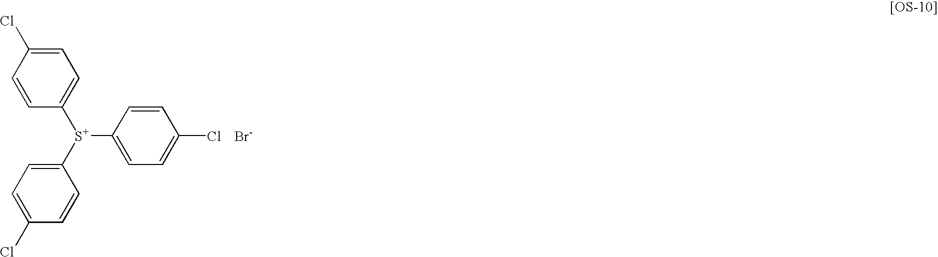

The radical generator used in the invention preferably has a maximum absorption wavelength of 400 nm or less. The maximum absorption wavelength is, more preferably, 360 nm or less and, most preferably, 300 nm or less. By adjusting the absorption wavelength in the ultraviolet region as described above, the lithographic printing plate precursor can be handled under an incandescent lamp.

The polymerization initiator is contained in the image recording layer at a mass ratio larger by 5 to the infrared ray absorbing dye. The mass ratio is, preferably, larger than 5 and smaller than 10 and, particularly preferably, larger than 5 and smaller than 8. Within the range, good sensitivity and printing durability can be obtained. In a case where the mass ratio is less than 5, a polymerization efficiency overcoming the polymerization inhibiting effect of the infrared ray absorbing dye can not be obtained. On the other hand, if it exceeds 10, it results in a disadvantage such as causing precipitation of the polymerization initiator in the image recording layer.

The polymerization initiator is contained, preferably, by 0.1 to 50 mass % in the image recording layer. It is, more preferably, from 0.5 to 30 mass % and, particularly preferably, from 1 to 20 mass %. Within the range described above, good sensitivity and good contamination durability for the non-image area during printing can be obtained. The polymerization initiator can be used alone or two or more of them may be used in combination. Further, another layer may be provided separately from the image recording layer and the polymerization initiator can be added also therein.

((C) Polymerizable Compound)

The polymerizable compound used in the invention is an addition polymerizable compound having at least one ethylenically unsaturated double bond, which is selected from compounds having at least one and, preferably, two or more of ethylenically unsaturated terminal bonds. Such a group of compounds is generally known in the relevant field of industry and they can be used with no particular restriction in the invention. They have a chemical form such as monomer, or prepolymer, that is, dimer, trimer and oligomer or a mixture thereof, as well as copolymer thereof. Examples of the monomer and copolymer thereof can include unsaturated carboxylic acids (for example, acrylic acid, methacrylic acid, itaconic acid, crotonic acid, isocrotonic acid, and maleic acid) and esters and amides thereof and, preferably, esters of unsaturated carboxylic acids and aliphatic polyhydric alcohol compounds, and amides of unsaturated carboxylic acids and aliphatic polyvalent amine compounds are used preferably. Further, addition reaction products of esters or amides of unsaturated carboxylic acids having nucleophilic substituent such as a hydroxyl group, amino group or mercapto group and mono-functional or poly-functional isocyanates or epoxides, as well as dehydrogenated condensation reaction products with mono-functional or poly-functional carboxylic acids can also be used suitably. Further, addition reaction products of esters or amindes of unsaturated carboxylic acids having electronphilic substituent such as isocyanate groups or epoxy group and mono-functional or poly-functional alcohols, amines and thiols and, further, substituent reaction products of esters or amides of unsaturated carboxylic acids having splitting substituent such as halogen group or tosyloxy group and mono-functional or poly-functional alcohols, amines and thiols are also preferred. Further, as other examples, a group of compounds in which the unsaturated carboxylic acids described above are replaced with unsaturated phosphonic acid, styrene or vinyl ether can also be used.

Specific examples of the ester monomers of aliphatic polyhydric alcohol compounds and unsaturated carboxylic acid can include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylol propane triacrylate, trimethylol propane tri(acryloyloxypropyl) ether, trimethylol ethane triacrylate, hexane diol diacrylate, 1,4-cyclohexane diol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanulate and polyester acrylate oligomer.

The methacrylate esters can include, for example, tetramethylene glycol dimethacrylate, trimethylene glycol dimethacrylate, neopentyl glycol dimethacrylate, trimethylol propane trimethacrylate, trimethylol ethane trimethacrylate, ethylene glycol dimethacrylate, 1,3-butane diol dimethacrylate, hexane diol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethyl methane, and bis-[p-(methacryloxyethoxy)phenyl]dimethylmethane.

The itaconate esters can include, for example, ethylene glycol diitaconate, propylene glycol diitaconate, 1,3-butane diol diitaconate, 1,4-butane diol diitaconate, tetramethylene glycol diitaconate, pentaerythritol diitaconate, and sorbitol tetraitaconate. The crotonate esters can include, for example, ethylene glycol dicrotonate, tetramethylene glycol dicrotonate, pentaerythritol dicrotonate, and sorbitol tetradicrotonate. The isocrotonate esters can include ethylene glycol diisocrotonate, pentaerithritol diisocrotonate, and sorbitol tetracrotonate. The maleate esters can include ethylene glycol dimaleate, triethylene glycol dimaleate, pentaerythritol dimaleate, and sorbitol tetramaleate.

As other examples of the esters, aliphatic alcohol type esters described in each of the publications of JP-B Nos. 46-27926 and 51-47334 and JP-A No. 57-196231, those having aromatic skeletons described in each of the publications of JP-A Nos. 59-5240, 59-5241, and 2-226149 and those containing the amino groups described in JP-A No. 1-165613 are also used preferably. Further, the ester monomers described above may also be used as a mixture.

Specific examples of the amide monomers of aliphatic polyfunctional amine compounds and unsaturated carboxylic acids can include methylene bis-acrylamide, methylene bis-methacrylamide, 1,6-hexamethylene bis-acrylamide, 1,6-hexamethylene bis-methacrylamide, diethylene triamine trisacrylamide, xylylene bisacrylamide and xylylene bismethacrylamide. Examples of other preferred amide monomers can include those having a cycloxylene structure as described in JP-B No. 54-21726.

Further, the urethane type addition polymerizable compound prepared by using addition reaction between isocyanate and hydroxyl group is also preferred and the specific example thereof can include, for example, a vinyl urethane compound containing two or more polymerizable vinyl groups in one molecule obtained by adding a vinyl monomer containing a hydroxyl group represented by the following general formula (IV) to a polyisocyanate compound having two or more isocyanate groups in one molecule described in JP-B No. 48-41708.
CH₂═C(R₄) COOCH₂CH(R₅) OH (IV)
(where R₄ and R₅ each presents H or CH₃).

Further, urethane acrylates as described in JP-A No. 51-37193 and JP-B Nos. 2-32293 and 2-16765, and urethane compounds having ethylene oxide type skeletons described in JP-B Nos. 58-48860, 56-17654, 62-39417 and 62-39418 are also suitable. Further, a photopolymereizabale composition of excellent photosensitive speed can be obtained by using an addition polymerizable compounds having an amino structure or sulfide structure in the molecule as described in JP-A Nos. 63-277653, 63-260909, and 1-105238.

Other examples can include poly-functional acrylates or methacrylates such as epoxy acrylates obtained by reacting polyester acrylates, epoxy resins and (meth)acrylic acid as described in each of the publications of JP-A No. 48-64183 and JP-B Nos. 49-43191 and 52-30490. Further, they can also include, for example, specified unsaturated compounds described in JP-B Nos. 46-43946, 1-40337 and 1-40336, and vinyl phosphonic acid compounds as described in JP-A No. 2-25493. Depending on the case, a structure containing the perfluoroalkyl group described in JP-A No. 61-22048 can be used suitably. Further, those presented as photo-curable monomers and oligomers described in the Journal of Japan Adhesion Society, vol. 20, No. 7, pages 300 to 308 (1984) can also be used.

Details for the structure and the method of using such polymerizable compounds described above such as use alone or in combination, or addition amount can be set optionally in accordance with the design for the performance of the final lithographic printing plate precursor. For example, they are selected with the following view points.

With a view point of the sensitivity, a structure of a high unsaturated group content per one molecule is preferred and di- or higher functionality is often preferred. Further, those having tri- or higher functionality are preferred in order to increase the strength in an image area, that is, a hardened film and, further, it is also effective to adopt a method of controlling both the sensitivity and the strength by the combined use of materials having different functionality and different polymerizable groups (for example, acrylic ester, methacrylic ester, styrenic compound and vinyl etheric compound).

Further, the selection and method of use for the polymerizable compound are also important factors in view of the compatibility and dispersibility with other ingredients in the image recording layer (for example, binder polymer, initiator and colorant) and the compatibility can be sometimes improved, for example, by the use of a compound at low impurity or by the combined use of two or more kinds of them. Further, a specified structure may also be selected with an aim of improving adhesion with a support or an overcoat layer to be described later.

The polymerizable compound is used in the image recording layer in a range, preferably, from 5 to 80 mass % and, more preferably, from 25 to 75 mass %. Further, they may be used alone or two or more of them may be used in combination. In addition, for the method of using the polymerizable compound, appropriate structure, blending and addition amount can optionally be selected with a view point for the degree of polymerization inhibition relative to oxygen, resolution power, fogging property, change of refractive index and surface tackiness and, further, layer constitution and coating method such as provision of undercoating or top coating may be conducted depending on the case.

(Binder Polymer)

In the invention, a binder polymer can be used for improving the film property and the developability on printing press of the image recording layer. As the binder polymer, those known so far can be used with no restriction and linear organic polymers having film forming property are preferred. Example of the binder polymer can include acrylic resin, polyvinyl acetal resin, polyurethane resin, polyurea resin, polyimide resin, polyamide resin, epoxy resin, methacrylic resin, polystyrenic resin, novolac type phenolic resin, polyester resin, synthesis rubber and natural rubber.

In order to improve the film strength in the image area, the binder polymer preferably has a crosslinkability. The binder polymer can be provided with the crosslinkability by introducing the crosslinking functional group such as an ethylenically unsaturated bond into the main chain or side chain of a polymer. The crosslinking functional group may also be introduced by copolymerization or by polymeric reaction.

A polymer having an ethylenically unsaturated bond in the main chain of the molecule can include, for example, poly-1,4-butadiene and poly-1,4-isoprene.

A polymer having an ethylenically unsaturated bond in the side chain of the molecule can include, for example, a polymer of an ester or an amide of acrylic acid or methacrylic acid, which is a polymer in which at least a portion of the residue of the ester or the amide (R in —COOR or —CONHR) has an ethylenically unsaturated bond.

The residue (R in the description above) having an ethylenically unsaturated bond can include, for example, —(CH₂)ₙCR¹═CR²R³, —(CH₂O)ₙCH₂CR¹═CR²R³, —(CH₂CH₂O)ₙCH₂CR¹═CR²R³, —(CH₂) NH—CO—O—CH₂CR¹═CR²R³, —(CH₂) n-O—CO—CR¹═CR²R³ and —(CH₂CH₂O)₂—X (wherein R¹ to R³ each represents a hydrogen atom, a halogen atom or an alkyl group of from 1 to 20 carbon atoms, an aryl group, alkoxy group or aryloxy group, and R¹ and R² or R³ may be bonded to form a ring. n represents an integer of from 1 to 10 and X represents a dicyclopentadienyl residue).

Specific examples of the ester residue can include —CH₂CH═CH₂, —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂OCOC(CH₃)═CH₂, —CH₂CH₂OCOCH═CH₂, —CH₂CH₂—NHCOO—CH₂CH═CH₂ and —CH₂CH₂O—X (wherein X represents a dicyclopentadienyl residue).

Specific examples of the amide residue can include —CH₂CH═CH₂, —CH₂CH₂—Y (wherein Y represents a cyclohexane residue), —CH₂CH₂—OCO—CH═CH₂.

The binder polymer having crosslinkability is hardened, for example, by addition of a free radical (polymerization initiating radical or a growing radical of a polymerizable compound during polymerization) to the cross-linking functional group thereof, and addition polymerization between the polymers directly or by way of a polymer chain of the polymerizable compound and crosslinking formed between the polymer molecules. Alternately, it is hardened by extraction of atoms in the polymer (for example, hydrogen atoms on carbon atoms in adjacent with the functional cross-linking groups) by free radials to form polymer radicals, which are bonded with each other to form cross-linking between the polymer molecules.

The content of the cross-linking group in the binder polymer (the content of the radical polymerizable unsaturated double bond by iodine titration) is, preferably, from 0.1 to 10.0 mmol, more preferably, from 1.0 to 7.0 mmol and most preferably, from 2.0 to 5.5 mmol based on 1 g of the binder polymer. Satisfactory sensitivity and good store stability can be obtained with the range described above.

Further, in view of the improvement of the developing property on printing press of an unexposed area of the image recording layer, it is preferred that the binder polymer has high solubility or dispersibility to an ink and/or fountain solution.

In order to improve the solubility or dispersibility to the ink, the binder polymer is preferably oleophilic and, in order to improve the solubility or dispersibility relative to fountain solution, the binder polymer is preferably hydrophilic. Therefore, it is also effective to use an oleophilic binder and a hydrophilic binder in combination in the invention.

A hydrophilic binder polymer can include, for example, those having a hydrophilic group such as a hydroxyl group, carboxyl group, carboxylate group, hydroxyethyl group, polyoxyethyl group, hydroxypropyl group, polyoxypropyl group, amino group, aminoethyl group, aminopropyl group, ammonium group, amide group, carboxymethyl group, sulfonate group and phosphonate group.

Specific examples can include, for example, gum Arabic, casein, gelatin, starch derivatives, carboxy methyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymer and copolymer of hydroxypropyl methacrylate, homopolymers and copolymers of hydroxypropyl acrylate, homopolymer and copolymer of hydroxybutyl methacrylate, homopolymers and copolymers of hydroxybutyl acrylate, polyethylene glycols, hydroxypropylene polymers, polyvinyl alcohols, hydrolyzed polyvinyl acetate having degree of hydrolyzation of 60 mass % or more, preferably, 80 mass % or more, polyvinyl formal, polyvinyl butyral, polyvinyl pyrrolidone, homopolymers and copolymers of acrylamide, homopolymers and polymers of methacrylamide, homopolymers and copolymers of N-methylol acrylamide, polyvinyl pyrrolidone, alcohol-soluble nylon, polyether of 2,2-bis-(4-hydroxyphenyl)-propane and epichlorohydrin.

The binder polymer has a weight average molecular weight of, preferably, from 5000 or more, more preferably, from 10,000 to 300,000, and has a number average molecular weight of, preferably, from 1000 or more and, more preferably, from 2,000 to 250,000, and has a polydispersibility (weight average molecular weight/number average molecular weight) of, preferably, from 1.1 to 10.

The binder polymer may be any of a random polymer, block polymer, graft polymer and the like, but it is preferably a random polymer.

The binder polymer of the invention can be synthesized by a method known so far. Among them, a binder polymer having a cross-linking group in the side chain can easily be synthesized by radical polymerization or polymer reaction. As a radical polymerization initiator to be used for the radical polymerization, known compounds such as azo-type initiators and peroxide initiators can be used. A solvent to be used for synthesis can include, for example, tetrahydrofuran, ethylene dichloride, cyclohexanone, methyl ethyl ketone, acetone, methanol, ethanol, ethylene glycol monomethylether, ethyleneglycol monoethyl ether, 2-methoxyethyl acetate, diethyleneglycol dimethyl ether, 1-methoxy-2-propanol, 1-methoxy-2-propylacetate, N,N-dimethylformamide, N,N-dimethylacetoamide, toluene, ethyl acetate, methyl lactate, ethyl lactate, dimethylsulfoxide, and water. They are used alone or in admixture of two or more of them.

The binder polymers are used alone or in admixture of two or more of them.

The content of the binder polymer is, preferably, from 10 to 90 mass %, more preferably, from 20 to 80 mass % and, most preferably, from 30 to 70 mass % based on the total solid content in the image recording layer. A satisfactory strength of an image area and image forming properties can be obtained within the range described above.

Further, it is preferred that the polymerable compound and the binder polymer are used in an amount of from 1/9 to 7/3 by a mass ratio.

In the invention, as a method of incorporating the constituent ingredients of the image recording layer described above and other constituent ingredients to be described later, several embodiments can be adopted. One of them is, for example, a molecule dispersion type image recording layer prepared by coating constituent ingredients while being dissolved in an appropriate solvent as described in JP-A-No. 2002-287334. Another embodiment is, for example, a microcapsule-type image recording layer in which at least one of constituent ingredients is micro-encapsulated and contained in the image recording layer as described in JP-A-2001-277740 and JP-A-2001-277742. Further, in the micro-encapsulated image-recording layer, the constituent ingredients may be contained at outside of the microcapsules. In this case, a preferred embodiment of the microcapsule-type image recording layer contains hydrophobic constituent ingredients in microcapsules, and hydrophilic ingredients at outside of the microcapsules. In order to obtain more satisfactory developability on printing press, it is preferred that the image recording layer is a microcapsule-type image recording layer.

As a method of microencapsulating the constituent ingredients of the image recording layer, known methods can be used. For example, a method of manufacturing microcapsules can include, for example, methods of using coacervation as described in the specifications of U.S. Pat. Nos. 2,800,457 and 2,800,458, methods of using interfacial polymerization as described in the specification of U.S. Pat. No. 3,287,154, JP-B No. 38-19574 and JP-B No. 42-446, methods by precipitation of polymers as described in U.S. Pat. Nos. 3,418,250 and 3,660,304, a method of using an isocyanate polyol wall material as described in the specification of U.S. Pat. No. 3,796,669, a method of using an isocyanate wall material as described in the specification of U.S. Pat. No. 3,914,511, methods of using urea-formaldehyde-type and urea-formaldehyde-resorcinol-type wall-forming materials described in the specifications of U.S. Pat. Nos. 4,001,140, 4,087,376 and 4089802, methods of using wall materials such as melamine-formaldehyde resin and hydroxycellulose as described in the specification of U.S. Pat. No. 4,025,445, an in-situ method by monomer polymerization as described in each publication of JP-B Nos. 36-9163 and 51-9079, a spray drying method as described in the specifications of GB-P No. 930422 and U.S. Pat. No. 3,111,407, and an electrolytic dispersion cooling method as described in each of the specifications of GB-P Nos. 952807 and 967074.

A preferred microcapsule wall to be used in the invention has three-dimensional crosslinking, and has a solvent-swelling property. In view of the above, preferred wall materials of the microcapsule are polyurea, polyurethane, polyester, polycarbonate, polyamide and a mixture thereof and, particularly, polyurea and polyurethane are preferred. Further, a compound having a crosslinkable functional group such as an ethylenically unsaturated bond capable of introducing the binder polymer may be introduced to the microcapsule wall.

The average grain size of the microcapsule is, preferably, from 0.01 to 3.0 μm. It is, more preferably, from 0.05 to 2.0 μm and, most preferably, from 0.10 to 1.0 μm. Preferred resolution power and aging stability can be obtained within the range described above.

(Other Additives)

The image recording layer of the invention may be incorporated with other additives than the ingredients described above, for example, surfactants, colorants, printing-out agents, polymerization inhibitors, high fatty acid derivatives, plasticizers, fine inorganic particles, and low molecular hydrophilic compounds. Such additives may be added in a molecule-dispersed state to the image recording layer, but they may optionally be incorporated in microcapsules together with the polymerizable compound.

< Surfactant >

In the invention, it is preferred to use a surfactant for the image recording layer in order to promote the developability on printing press upon starting printing, and in order to improve the state of coated surface. The surfactant can include nonionic surfactants, anionic surfactants, cationic surfactants, amphoteric surfactants, and fluoro surfactants. The surfactants may be used alone or in admixture of two or more of them.

The nonionic surfactant to be used in the invention has no particular restriction, and those known so far can be used. They can include for example, polyoxyethylene alkyl ethers, polyoxyethylene alkylphenylethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylene alkylamine, triethanolamine fatty acid esters, trialylamine oxide, polyethylene glycol, copolymers of polyethylene glycol, and polypropylene glycol.

The anionic surfactant to be used in the invention has no particular restriction, and those known so far can be used. They can include, for example, fatty acid salts, abietate salts, hydroxyalkane sulfonate salts, alkane sulfonate salts, dialkyl sulfosuccinate ester salts, linear alkyl benzene sulfonate salts, branched alkyl benzene sulfonate salts, alkylnaphthalene sulfonate salts, alkyl phenoxypolyoxy ethylene propylsulfonate salts, polyoxyethylene alkylsulfophenyl ether salts, sodium N-methyl-N-oleyltaurinate salt, disodium N-alkylsulfosuccinate monoamide salt, petroleum sulfonate salts, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styrylphenyl ether sulfate ester salts, alkyl phosphate ester salts, polyoxyethylene alkyl ether phosphate ester salts, polyoxyethylene alkyl phenyl ether phosphate ester salts, partial saponification products of styrene/maleic acid copolymer, partial saponification products of olefin/maleic acid copolymer, and naphthalene sulfonate formalin condensates.

The cationic surfactant to be used for the invention has no particular restriction, and those known so far can be used. They can include, for example, alkylamine salts, quaternary ammonium salts, polyoxyethylene alkyl amine salts, and polyethylene polyamine derivatives.

The amphoteric surfactant to be used in the invention has no particular restriction, and those known so far can be used. They can include, for example, carboxybetaines, aminocarboxylic acids, sulfobetaines, aminosulfate esters, and imidazolines.

Further, among the surfactants described above, “polyoxyethylene” can be reworded as “polyoxyalkylene”, such as polyoxymethylene, polyoxypropylene and polyoxybutylene, and surfactants containing them can be used in the invention.

Further, preferred surfactants can include, for example, fluoro surfactants containing a perfluoroalkyl group in the molecule. The fluoro surfactants can include, for example, anionic-type such as perfluoroalkyl carboxylate, perfluoroalkyl sulfonate, and perfluoroalkylphosphate; amphoteric type such as perfluoroalkyl betaines; cationic type such as perfluoroalkyl trimethyl ammonium salts, and nonionic type such as perfluoroalkyl amine oxides, perfluoroalkyl ethylene oxide adducts, oligomers containing a perfluoroalkyl group and a hydrophilic group, oligomers containing a perfluoroalkyl group and an oleophilic group, oligomers containing a perfluoroalkyl group, a hydrophilic group and an oleophilic group and urethanes containing a perfluoroalkyl group and an oleophilic group. Further, fluoro surfactants described in each publication of JP-A Nos. 62-170950, 62-226143 and 60-168144.

The surfactants can be used alone or in admixture of two or more of them.

The surfactant is contained in an amount, preferably, from 0.001 to 10 mass % and, more preferably, from 0.01 to 5 mass % in the image recording layer.

< Colorant >

Dyes having a large absorption in a visible light region can be used as colorants for images in the image recording layer of the invention. Specifically, they can include oil yellow #101, oil yellow #103, oil pink #312, oil green BG, oil blue BOS, oil blue #603, oil black BY, oil black BS, oil black T-505 (each, manufactured by Orient Chemical Industry Co.), Victoria pure blue, crystal violet (CI42555), methyl violet (CI42535), ethyl violet, rhodamine B(CI145170B), malachite green (CI42000), methylene blue (CI52015) and dyes described in JP-A No. 62-293247. Further, pigments such as phthalocyanine pigments, azo pigments, carbon black, and titanium oxide can also be used preferably.

It is preferred that the colorants are added since the image area and non-image area are easily distinguished after the formation of the image. The addition amount is, preferably, at a ratio from 0.01 to 10 mass % in the image recording layer.

<Printing-Out Agent>

To the image recording layer of the invention, compounds causing discoloration by an acid or a radical can be added in order to form print-out images. As such compounds, various kinds of colorants, for example, diphenylmethane type, triphenylmethane type, triazine type, oxazine type, xanthene type, anthraquinone type, iminoquinone type, azo type dyes can be used effectively.

Specific examples can include dyes such as brilliant green, ethyl violet, methyl green, crystal violet, basic fuchsine, methyl violet 2B, quinaldine red, rose Bengal, methanyl yellow, thimol sulfophthalein, xylenol blue, methyl orange, paramethyl red, Congo red, benzo purpurin 4B, α-naphtyl red, Nile blue 2B, Nile blue A, methyl violet, malachite green, parafuchsine, Victoria pure blue BOH [manufactured by Hodogaya Chemical Co.], oil blue #603 [manufactured by Orient Chemical Industry Co.), oil pink #312 [manufactured by Orient Chemical Industry Co.], oil red 5B [manufactured by Orient Chemical Industry Co.], oil scarlet #308 [manufactured by Orient Chemical Industry Co.], oil red OG [Orient Chemical Industry Co.], oil red RR [manufactured by Orient Co.], oil green #502 [manufactured by Orient Chemical Industry Co.], Spiron Red BEH special [manufactured by Hodogaya Chemical Industry], m-cresol purple, cresol red, rhodamine B, rhodamine 6G, sulfo rhodamine B, auramine, 4-p-diethylaminophenyl iminonaphthoquione, 2-carboxyanilino-4-p-diethyl aminophenyliminonaphthoquinone, 2-carboxystearyl amino-4-p-N,N-bis(hydroxyethyl) amino-phenylimino naphthoquinone, 1-phenyl-3-methyl-4-p-diethylamino phenylimino-5-pyrazolon, and 1-β-naphtyl-4-p-diethylaminophenyl imino-5-pyrazolon, and leuco dyes such as p,p′,p″-hexamethyltriaminotriphenyl methane (leuco crystal violet), and Pergascript Blue SRB (manufactured by Ciba Geigy Co.].

In addition to those described above, leuco dyes known as materials for heat sensitive paper and pressure sensitive paper can also be used suitably. Specific examples can include, for example, crystal violet lactone, malachite green, lactone, benzoyl leucomethylene blue, 2-(N-phenyl-N-methylamino)-6-(N-p-tolyl-N-ethyl)amino-fluoran, 2-anilino-3-methyl-6-(n-ethyl-p-tolidino) fluoran, 3,6-dimethoxyfluoran, 3-(N,N-diethylamino)-5-methyl-7-(N,N-dibenzylamino)-fluoran, 3-(N-cyclohexyl-N-methylamino)-6-methyl-7-anilinofluoran, 3-(N-N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-pipelidino-6-methyl-7-anilinofluoran, 3-pyrolidino-6-methyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide.

It is preferred that the dye discolored by an acid or a radical is contained at a ratio from 0.001 to 10 mass % in the image recording layer.

< Thermal Polymerization Inhibitor >

In the image recording layer of the invention, it is preferred to add a small amount of a thermal polymerization inhibitor for preventing unnecessary thermal polymerization of the polymerizable compound (C) during manufacture or storage of the image recording layer.

Thermal polymerization inhibitor can include, preferably, hydroquinone, p-methoxyphenyl, di-t-butyl-p-cresol, pyrogallol, t-butyl catechol, benzoquinone, 4,4′-thiobis (3-methyl-6-t-butylphenol), 2,2′-methylene bis (4-methyl-6-t-butylphenol), and N-nitroso-N-phenylhydroxylamine aluminum salt.

The thermal polymerization inhibitor is incorporated in the image recording layer, preferably, by about from 0.01 to about 5 mass %.

<Higher Fatty Acid Derivatives, etc. >

In the image recording layer of the invention, higher fatty acid derivatives, etc. such as behenic acid and behenic acid amide may be added and localized on the surface of the image recording layer during drying after coating in order to prevent inhibition of polymerization by oxygen. The addition amount of the higher fatty acid derivative is, preferably, from about 0.1 to about 10 mass % based on the total solid content of the image recording layer.

< Plasticizer >

The image recording layer of the invention may also contain a plasticizer in order to improve the developability on printing press.

The plasticizer can include, preferably, for example, phthalate esters such as diemthylphthalate, diethylphthalate, dibutylphthalate, diisobutylphthalate, dioctylphthalate, octylcaprylphthalate, dicyclohexylphthalate, ditridecylphthalate, butylbenzylphthalate and diisodecylphthalate and diallylphthalate; glycol esters such as dimethylglycolphthalate, ehtylphtarylethylglycolate, methylphtharylethylglycolate, butylphtharylbutylglycolate, triethylene glycol dicaprylate ester; phosphate esters such as tricresylphosphate and triphenylphosphate; aliphatic dibasic acid esters such as diisobutyladipate, dioctyladipate, dimethylsebakate, dibutylsebakate, dioctylazelate and dibutylmaleate; polyglycidylmethacrylate, triethyl citrate, glycerin triacetyl ester, and butyl laurate.

It is preferred that the plasticizer is contained, preferably, at a ratio of about 30 mass % or less in the image recording layer.

< Fine Inorganic Particle >

The image recording layer of the invention may contain fine inorganic particles in order for reinforcement of interface adhesion by surface roughening, improvement of hardened film strength of the image area and improvement of developability on printing press of the non-imaging area.

Preferred examples of the fine inorganic particles can include silica, alumina, magnesium oxide, titanium oxide, magnesium carbonate, calcium alginate or a mixture of them.

The fine inorganic particles have an average grain size, preferably, from 5 nm to 10 μm and, more preferably, from 0.5 μm to 3 μm. In the range described above, they are dispersed stably in the image recording layer, sufficiently keep the film strength of the image recording layer and can form a non-imaging area of causing less contamination during printing and having excellent hydrophilicity.

The fine inorganic particles described above are easily available as commercial products, for example, as colloidal silica dispersions.

The content of the fine inorganic particles is preferably 20 mass % or less and, more preferably, 10 mass % or less based on the entire solid content of the image recording layer.

< Low Molecular Hydrophilic Compound >

The image recording layer in the invention may contain a hydrophilic low molecular compound in order to improve the on printing press. The hydrophilic low molecular compound, for example, water soluble organic compounds can include, for example, glycols such as ethylene glycol, diethylene glycol, triethylene glycol, propylene glycol, dipropylene glycol and tripropylene glycol, and ether or ester derivatives thereof, polyhydroxy compounds such as glycerine and pentaerythritol, organic amines such as triethanol amine, diethanol amine, monoethanol amine, and salts thereof, organic sulfonic acids such as toluene sulfonic acid and benzene sulfonic acid, and salts thereof, organic phosphonic acids such as phenyl phosphonic acid and salts thereof, organic carboxylic acids such as tartaric acid, oxalic acid, citric acid, maleic acid, lactic acid, glyconic acid, amino acids, and salts thereof.

[Formation of Image Recording Layer]

For the image recording layer of the invention, each of the necessary ingredients described above are dispersed or dissolved in a solvent to prepare a coating solution for coating. The solvent used herein can include, for example, ethylene dichloride, cyclohexanone, methyl ethyl ketone, methanol, ethanol, propanol, ethylene glycol monomethyl ether, 1-methoxy-2-propanol, 2-methxyethyl acetat, 1-methoxy-2-propyl acetate, dimethoxyethane, methyl lactate, ethyl lactate, N,N-dimethyl acetoamide, N,N-dimethyl formamide, tetramethyl urea, N-methylpyrrolidone, dimethyl sulfoxide, sulfolane, γ-butyl lactone, toluene and water, with no restriction to them. The solvents described above can be used alone or in admixture. The solid concentration of the coating solution is preferably from 1 to 50 mass %.

The image recording layer in the invention can be formed also by preparing plural coating solutions prepared by dispersing or dissolving identical or different ingredients described above into identical or different solvents and repeating coating and drying for plural times.

Further, the coating amount of the image recording layer (solid content) on the support obtained after coating and drying is different depending on the application use and, generally, it is preferably from 0.3 to 3.0 g/m². Within the range, a good sensitivity and a good film property for the image recording layer can be obtained.

Various methods can be used for the coating method. They can include, for example, bar coater coating, spin coating, spray coating, curtain coating, dip coating, air knife coating, blade coating and roll coating.

[Support]

The support used for the lithographic printing plate precursor of the invention has no particular restriction so long as it is a dimensionally stable plate-like material. The support can include, for example, paper, paper laminated with plastic (for example, polyethylene, polypropylene, polystyrene, etc.), metal plate (for example, of aluminum, zinc, copper, etc.), plastic film (for example, of cellulose diacetate, cellulose triacetate, cellulose propionate, cellulose butyrate, cellulose acetobutyrate, cellulose nitrate, polyethylene terephthalate, polyethylene, polypropylene, polycarbonate, polyvinyl acetal, etc.) and paper or plastic film laminated or vapor deposited with the metal described above. A preferred support can include, a polyester film and an aluminum plate. Among all, an aluminum plate which has excellent dimensional stability and is relatively inexpensive is preferred. Further, hydrophilic support is particularly preferred.

The aluminum plate is a pure aluminum plate, an alloy plate comprising aluminum as a main ingredient and containing a trace amount of hetero elements, or a thin film of aluminum or aluminum alloy laminated with plastic material. The hetero element contained in the aluminum alloy is silicon, iron, manganese, copper, magnesium, chromium, zinc, bismuth, nickel and titanium. The content of the hetero element in the alloy is preferably 10 mass % or less. While pure aluminum plate is preferred in the invention, since completely pure aluminum is difficult to be produced in view of the refining technique, it may slightly contain the hetero element. The composition is not specified for the aluminum plate and those materials known and used publicly can be utilized properly.

The thickness of the support is, preferably, from 0.1 to 0.6 mm, more preferably, from 0.15 to 0.4 mm and, further preferably, from 0.2 to 0.3 mm.

Prior to the use of the aluminum plate, a surface treatment such as roughening treatment or anodizing treatment is preferably applied. The surface treatment facilitates improvement of the hydrophilic property and ensure for the adhesion between the image recording layer and the support. Prior to the roughening treatment for the aluminum plate, a degreasing treatment, for example, with a surfactant, an organic solvent or an aqueous alkaline solution is applied optionally for removing oils on the surface use for rolling.

The roughening treatment for the surface of the aluminum plate is conducted by various methods and it can include, for example, mechanical roughening treatment, electrochemical roughening treatment (roughening treatment of electrochemically dissolving the surface) and chemical roughening treatment (roughening treatment of chemically dissolving the surface selectively).

As the method of the mechanical roughening treatment, known methods such as ball grinding, brush grinding, blast grinding and buff grinding can be used.

The electrochemical roughening treatment method can include, for example, a method of conducting by AC current or DC current in an electrolyte containing an acid such as hydrochloric acid or nitric acid. Further, it can also include a method of using a mixed acid as described in JP-A No. 54-63902.

The aluminum plate subjected to the roughening treatment is applied with an alkali etching treatment optionally by using an aqueous solution of potassium hydroxide or sodium hydroxide and, further, subjected to a neutralizing treatment and then applied with an anodizing treatment for improving the abrasion resistance as required.

As the electrolyte used for the anodizing treatment of the aluminum plate, various electrolytes of forming porous oxide films can be used. Generally, sulfuric acid, hydrochloric acid, oxalic acid, chromic acid or a mixed acid thereof is used. The concentration of the electrolyte can be determined properly depending on the kind of the electrolyte.

While the conditions for the anodizing treatment varies depending on the electrolytes used, they can not be defined generally but it is generally preferred for 1 to 80 mass % of electrolyte concentration in solution, 5 to 70° C. for liquid temperature, 5 to 60 A/dm² for current density, 1 to 100 V for voltage and 10 sec to 5 min for electrolysis time. The amount of the anodized film to be formed is, preferably, from 1.0 to 5.0 g/m² and, more preferably, from 1.5 to 4.0 g/m². Within the range, good printing durability and preferred scratch resistance can be obtained for the non-image area in a lithographic printing plate.

After applying the anodic treatment, a hydrophilic treatment is optionally applied to the surface of the aluminum plate. The hydrophilic treatment can include, an alkali metal silicate method as described in each of the specifications of U.S. Pat. Nos. 2,714,066, 3,181,461, 3,280,734 and 3,902,734. In this method, the support is put to a dipping treatment using an aqueous solution of sodium silicate, etc., or put to an electrolytic treatment. In addition, it can include, for example, a method of treating with potassium zirconium fluoride as described in JP-B No. 36-22063, a method of treating with polyvinyl phosphonic acid as described in each of the specifications of U.S. Pat. Nos. 3,276,868, 4,153,461, and 4,689,272.

The support has a center line average roughness, preferably, of from 0.10 to 1.2 μm. Within the range, good adhesion with the image recording layer, good printing durability, and good contamination durability can be obtained.

Further, the color density of the support is, preferably, from 0.15 to 0.65 as a reflection density value. Within the range, good image forming property due to anti-halation during image exposure and good plate inspectability after development can be obtained.

[Back Coat]

After applying the surface treatment or forming the undercoat layer to the support, a back coat can be disposed optionally to the back surface of the support.

The back coat can include, preferably, for example an organic polymeric compound described in JP-A No. 5-45885, a coating layer comprising a metal oxide obtained by hydrolyzing and polycondensating an organic metal compound or an inorganic metal compound described in JP-A No. 6-35174. Among them, use of a silicon alkoxy compound such as Si(OCH₃)₄, Si(OC₂H₅)₄, Si(OC₃H₇)₄, and Si(OC₄H₉)₄ is preferred since the starting material is inexpensive and easily available.

[Protection Layer]

In the lithographic printing plate precursor according to the invention used for the lithographic printing method of the invention, a protection layer may be disposed optionally on the image recording layer for preventing the occurrence of scratches oxygen shielding and anti-abrasion upon laser exposure at high illuminance in the image recording layer.

In the invention, while exposure is conducted usually in an atmospheric air, and the protection layer prevents intrusion of oxygen, basic substance, etc. present in atmospheric air that hinders image forming reaction in the image recording layer by exposure thereby preventing hindrance to the image forming reaction by exposure in atmospheric air. Accordingly, characteristics desirable for the protection layer are that the permeability to low molecular compound such as oxygen is low and, further, permeation of light used for exposure is good, adhesion with the image recording layer is excellent, and it can be removed easily by the developing step on the printing press after exposure. The protection layers having such characteristics have been studied variously so far and described specifically, for example, in the specification of U.S. Pat. No. 3,458,311 and in JP-A No. 55-49729.

The material used for the protection layer can include, for example, water soluble polymeric compounds of relatively excellent crystallinity. Specifically, they include water soluble polymers such as polyvinyl alcohol, polyvinyl pyrrolidone, acidic cellulose, gelatin, gum arabic and polyacrylic acids. Among them, use of polyvinyl alcohol (PVA) as the main ingredient can provide most preferred result for basic characteristics such as oxygen shielding property and removability upon development. The polyvinyl alcohol may be partially substituted with ester, ether, or acetal and partially has other copolymerizing ingredients so long as it contains not-substituted vinyl alcohol units for providing the protection film with necessary oxygen shielding property and water solubility.

Specific examples of the polyvinyl alcohol can include preferably those hydrolyzed by 71 to 100% and having a molecular weight ranging from 300 to 2400. Specifically, they can include, for example, PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8 manufactured by Kurarey Co.

The ingredient (selection of PVA, use of additive) of the protection layer and the coating amount are selected properly while considering the oxygen shielding property and the removability upon development, as well as fogging property, adhesion and scratch resistance. Generally, as the hydrolysis rate of PVA is higher (that is, the content of not-substituted vinyl alcohol unit in the protection film is higher) and the thickness is larger, the oxygen shielding property is enhanced and it is preferred in view of the sensitivity. Further, for preventing occurrence of unnecessary polymerizing reaction during production and storage, unnecessary fogging upon image exposure and preventing enlargement of image lines, it is preferred that the oxygen permeability is not excessively high. Accordingly, the oxygen permeability A at 25° C. under 1 atm is preferably: 0.2≦A≦20 (cc/m² day).

The molecular weight of the (co)polymer such as polyvinyl alcohol (PVA) described above usable herein is within a range from 2,000 to 10,000,000 and, preferably, those within a range of 20,000 to 3,000,000 are appropriate.

As other composition for the protection layer, glycerine, dipropylene glycol, etc. can be added to the (co)polymer by an amount corresponding to several mass % thereby providing flexibility. Further, anionic surfactant such as sodium alkyl sulfate or sodium alkyl sulfonate; amphoteric surfactant such as alkylamino carboxylate salt or alkylamino dicarboxylate salt; and non-ionic surfactant such as polyoxyethylene alkylphenyl ether can be added by several mass % to the (co)polymer.

The thickness of the protection film is, property, from 0.1 to 5 μm, and, particularly suitably, from 0.2 to 2 μm.

Further, adhesion with the image area, the scratch resistance, etc. of the protection layer are also extremely important in view of the handling of the lithographic printing plate precursor. That is, when a protection layer which is hydrophilic due to the incorporation of the water soluble polymeric compound is laminated on an oleophilic image recording layer, defoliation of the protection layer tends to occur due to the insufficiency of adhesion and it may sometimes result in defects such as poor film hardening caused by inhibition of polymerization by oxygen.

Various proposals have been made for improving the adhesion between the image recording layer and the protection layer. For example, JP-A No. 49-70702 and the specification of BP-A No. 1303578 describe that a sufficient adhesion can be obtained by mixing from 20 to 60 mass % of an acrylic emulsion, a water insoluble vinyl pyrrolidone—vinyl acetate polymer, etc. in a hydrophilic polymer mainly comprising polyvinyl alcohol and laminating them on an image recording layer. In the invention, any of the known techniques can be used. The coating method of the protection layer is described specifically, for example, in the specification of U.S. Pat. No. 3,458,311 and JP-A No. 55-49729.

Further, other functions can also be provided to the protection layer. For example, by adding a colorant excellent in the permeability for infrared rays used for exposure and capable of efficiently absorbing light at other wavelength (for example, water soluble dye), the safe light adaptability can be improved without lowering the sensitivity.

[Lithographic Printing Method]

In lithographic printing method according to the invention, the lithographic printing plate precursor according to the invention described above is imagewise exposed by an infrared ray laser.

The infrared laser used in the invention can include, preferably, a solid laser and a semiconductor laser emitting infrared rays at a wavelength from 760 to 1200 nm with no particular restriction. The power of the infrared laser is preferably 100 mW or more. Further, for shortening the exposure time, use of a multi-beam laser device preferred.

The exposure time per one pixel is, preferably, within 20μ sec. Further, the irradiation energy dose is, preferably, from 10 to 300 mJ/cm².

In the lithographic printing method according to the invention, the lithographic printing plate precursor according to the invention is imagewise exposed by the infrared laser and then an oily ink and an aqueous ingredient are supplied to conduct printing not by way of any developing step.

It can include, specifically, a lithographic printing method, which comprises;
loading a lithographic printing plate precursor to a printing press, the lithographic printing plate precursor comprising: a support; an undercoat layer; and an image recording layer containing a polymerization initiator, a polymerizable compound and an infrared ray absorbing agent, the image recording layer being removable with at least one of a printing ink and a fountain solution, in this order, wherein the undercoat layer contains a compound having (a) an ethylenically unsaturated bond and (b) a functional group capable of adsorbing to a surface of the support;
imagewise exposing the lithographic printing plate precursor with a laser, before or after the loading;
supplying a printing ink and fountain solution to the lithographic printing plate precursor so as to remove a not-exposed area in the image recording layer by at least one of a printing ink and a fountain solution; and
printing.

After imagewise exposing the lithographic printing plate precursor by an infrared laser, when an aqueous ingredient (fountain solution) and an oily ink (printing ink) are supplied not by way of a developing process such as a wet developing process to conduct printing, an image recording layer hardened by exposure forms an oily ink receiving area having an oleophilic surface in the exposed area of the image recording layer. On the other hand, in a not-exposed area, the not-hardened image recording layer is removed by dissolution or dispersion with the aqueous ingredient and/or oily ink supplied to reveal a hydrophilic surface at that area.

As a result, the aqueous ingredient is adhered on the revealed hydrophilic surface and the oily ink is deposited to the image recording layer at the exposed region and printing is started in this state. While either the aqueous ingredient or the oily ink may be supplied at first to the plate surface, it is preferred to supply the oily ink at first for preventing contamination of the aqueous ingredient with the image recording layer at the non-exposed area. For the aqueous ingredient and the oily ink, fountain solution and oily ink for usual lithographic printing are used.

In this way, the lithographic printing plate precursor is subjected to development on offset printing press and then used as it is for printing plurality of sheets.

### EXAMPLE

The present invention is to be described specifically by way of examples but the invention is not restricted to them.

1. Preparation of Lithographic Printing Plate Precursor

(1) Preparation of Support

A molten aluminum alloy according to JIS A 1050 containing 99.5 mass % or more of Al, 0.30 mass % of Fe, 0.10 mass % of Si, 0.02 mass % of Ti and 0.013 mass % of Cu, and the balance of inevitable impurities was applied with a cleaning treatment and then cast. As the cleaning treatment, a degasing treatment was applied for removing unnecessary gases in the molten alloy such as hydrogen and, further, a ceramic tube filtration was applied. Casting was conducted by a DC casting process. The surface of solidified cast ingots of 500 mm plate thickness was scraped by 10 mm and applied with a soaking treatment at 550° C. for 10 hours such that intermetallic compounds were not grown. Then, it was hot rolled at 400° C. and, after annealing in a continuous annealing furnace at 500° C. for 60 sec to apply intermediate annealing, it was cold rolled into an aluminum rolled sheet of 0.30 mm thickness. The centerline average roughness (Ra) after the cold rolling was controlled to 0.2 μm by controlling the roughness of the rolling roll. Then, for improving the planarity, it was applied to a tension leveller. The thus obtained aluminum sheet was put to the surface treatment shown below.

At first, for removing the rolling oil on the surface of the aluminum sheet, a degreasing treatment was applied at 50° C. for 30 sec by using an aqueous 10 mass % sodium aluminate solution and then applied with a neutralization and smut removing treatment at 50° C. for 30 sec by using an aqueous 30 mass % solution of sulfuric acid.

Then, a roughening treatment was applied for improving the adhesion between the image recording layer and the support and providing water retainability to a non-image area. Specifically, an electrochemical roughening treatment was applied by conducting electrolysis while passing a web of an aluminum sheet in an aqueous solution containing 1 mass % of nitric acid and 0.5 mass % of aluminum nitrate (liquid temperature at 45° C.) supplied to an indirect power supply cell, with an alternating waveform at a current density of 20 A/cm² and at a duty ratio of 1:1 such that the electric amount was 240 C/cm² when the aluminum plate functions as an anode.

Further, an etching treatment was applied at 50C for 30 sec by using an aqueous 10 mass % solution of sodium aluminate and then neutralizing and smut removing treatment was applied at 50° C. for 30 sec by using an aqueous 30 mass % solution of sulfuric acid.

Then, for improving the wear resistance, chemical resistance and water retainability, an anodic treatment was applied. Specifically, electrolysis was conducted while passing a web of an aluminum sheet in an aqueous 20 mass % solution of sulfuric acid (liquid temperature: 35° C.) supplied to an indirect power supply cell with AC current at a current density of 14 A/dm² to form an anodized film of 2.5 g/m², thereby preparing a support A for the lithographic printing plate precursor.

### Example 1

To the support A obtained as described above, a silicate treatment was applied by using an aqueous 1.5 mass % solution of No. 3 sodium silicate at 70° C. for 5 sec in order to ensure the hydrophilicity in a non-image area. The deposition amount of Si was 10 mg/m². Then, water washing was applied to obtain a support. The center line average roughness Ra of the obtained support was 0.25 μm.

Then, after coating an undercoat layer coating solution (1) of the following composition by using a bar so as to provide 7.5 ml/m² of liquid volume, it was oven-dried at 80° C. for 10 sec.

Undercoat layer coating solution (1)

| | | |
|---|---|---|
| Water | 15 | g |
| Methanol | 135 | g |
| The following compound A | 0.72 | g |

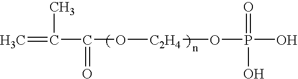

n = 4 ˜ 5 Compound A

Then, after bar coating an image recording layer coating solution (1) of the following composition, it was oven-dried at 100° C. for 60 sec and an image recording layer at a dry coating amount of 1.0 g/m² was formed to obtain a lithographic printing plate precursor (1).

Image recording layer coating solution (1)

| | | |
|---|---|---|
| The following infrared ray absorbing agent (1) | 0.05 | g |
| Polymerization initiator | | |
| (OS-7 described in the specification) | 0.2 | g |
| The following binder polymer (1) | 0.5 | g |
| (average molecular weight: 80,000) | | |
| Polymerizable compound | 1.0 | g |
| isocyanuric acid EO modified triacrylate | | |
| (NK ester M-315, manufactured by Shin Nakamura | | |
| Chemical Industry Co.) | | |
| Naphthalene sulfonate of Victoria Pure Blue | 0.02 | g |
| The following fluoro surfactant (1) | 0.1 | g |
| Methyl ethyl ketone | 18.0 | g |

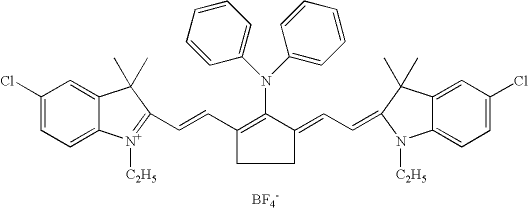

Infrared ray absorbing agent (1) 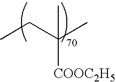 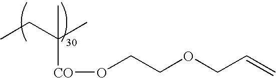
Binder polymer (1) 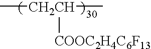 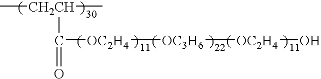
Fluoro surfactant (1)

### Example 2

A lithographic printing plate precursor (2) was prepared in the same procedures as those in Example 1 except for changing the addition amount for the compound A of the undercoating layer coating solution (1) in Example 1 from 0.72 g to 0.24 g.

### Example 3

A lithographic printing plate precursor (3) was prepared in the same procedures as those in Example 2 except for using a compound B instead of the compound A used in Example 2.

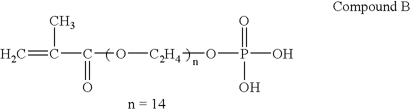

### Example 4

A lithographic printing plate precursor (4) was prepared in the same procedures as those in Example 1 except for changing the addition amount for the compound A of the undercoating layer coating solution (1) in Example 1 from 0.72 g to 0.024 g.

### Example 5

A silicate treatment was applied in the same manner as in Example 1 and, after bar coating an image recording layer coating solution (2) of the following composition on a support having an identical undercoat layer, it was oven-dried at 70° C. for 60 sec and an image recording layer at a dry coating amount of 0.8 g/m² was formed to obtain a lithographic printing plate precursor (5).

Image recording layer coating solution (2)

| | |
|---|---|
| Water | 100 g |
| The following micro capsule (1) (as solid content) | 5 g |
| Polymerization initiator | 0.5 g |
| (OS-7 described in the specification) | |
| The fluoro surfactant (1) described above | 0.2 g |

(Synthesis for Microcapsule (1))

As an oil phase ingredient, 10 g of trimethylol propane and xylene diisocyanate adduct (TAKENATE D-110N, manufactured by Mitsui Takeda Chemical Co.), 3.15 g of pentaerythritol triacrylate (SR444, manufactured by Nippon Kayaku Co.), 0.35 g of the following infrared ray absorbing agent (2), 1 g of 3-(N,N-diethylamino)-6-methyl-7-anilino fluoran (ODB, manufactured by Yamamoto Kasei Co.) and 0.1 g of PIONINE A-41C (manufactured by Takemoto Yushi Co.) were dissolved in 17 g of ethyl acetate. As an aqueous phase ingredient, 40 g of an aqueous 4 mass % solution of PVA-205 was prepared. The oil phase ingredient and the aqueous phase ingredient were mixed and emulsified by using a homogenizer at 12,000 rpm for 10 min. The resultant emulsion was added to 25 g of distilled water and, after stirring at a room temperature for 30 min, it was stirred at 40° C. for 3 hours. The thus obtained microcapsule liquid was diluted by using distilled water such that the solid concentration was 20 mass %. The average grain size was 0.3 μm.

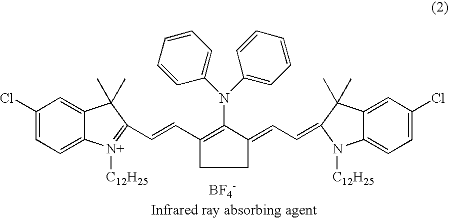

### Example 6

On the substrate A obtained by the preparation of the support, the same undercoat layer as in Example 1 was disposed without applying the silicate treatment. Then, after bar coating the image recording layer coating solution (2) in the same manner as in Example 5, it was oven-dried at 70° C. for 60 sec, and an image recording layer with a dry coating amount of 0.8 g/m² was formed to obtain a lithographic printing plate precursor (6).

[Comparative Example 1]

A lithographic printing plate precursor (7) was prepared in the same procedures as those in Example 1 except for not conducting the undercoat layer coating.

[Comparative Example 2]

A lithographic printing plate precursor (8) was prepared in the same procedures as those in Example 5 except for not conducting the undercoat layer coating.

[Comparative Example 3]

A lithographic printing plate precursor (9) was prepared in the same procedures as those in Example 6 except for not conducting the undercoat layer coating.

2. Exposure and printing

The thus obtained lithographic printing plate precursors were exposed imagewise by Trendsetter 3244VX manufactured by Creo Co. mounting thereon a water-cooled 40 W infrared semiconductor laser under the conditions at a power of 9 W, a rotational number of an outer surface drum of 210 rpm and a resolution of 2400 dpi. However, for microcapsule type lithographic printing plate precursors on Examples 5 and 6 and Comparative Examples 2 and 3, imagewise exposure was conducted at the number of drum rotation for the outer surface drum of 133 rpm and comparison was made.

The thus obtained exposed plates were loaded without developing treatment to a cylinder of a printing press SOR-M manufactured by Hyderberg Co. After supplying fountain solution and an ink by using fountain solution (EU-3, etching solution, manufactured by Fuji Photographic Film Inc.)/water/isopropyl alcohol=1/89/10 (volume ratio) and TRANS-G(N) black ink (manufactured by Dainippon Ink Chemical Industry Co.), printing was conducted at a printing speed of 6,000 sheets per hour.

The number of printing paper required till the removal of the unexposed area of the image recording layer on a printing press was completed to reach a state where the ink was not transferred to the printing paper was measured as the developability on printing press.

After completion of development on printing press, printing was further continued. Since the image recording layer was gradually abraded as the number of printing paper increased and the ink receptabity was lowered, ink concentration on the printing paper was lowered. The number of printed paper when the ink concentration (reflection concentration) was lowered by 0.1 from the start of printing was evaluated as the printing durability. In the course of the evaluation for the printing durability, background contamination was not caused in any of the plates.

Table 1 shows the result of evaluation for the developability on printing press and the printing durability.

TABLE 1
Examples to 6 and Comparative Examples 1 to 3

| | | | | | Number of |
|---|---|---|---|---|---|
| | | | | | sheet for |
| | Lithographic | | | Number of | development |
| | printing | | | sheet for | on |
| | plate | | Undercoat | printing | printing |
| | precursor | Image recording layer | layer | durability | press |
| Example 1 | 1 | Image recording layer | Compound A | 40000 | 40 |
| | | coating solution (1) | | | |
| Example 2 | 2 | Image recording layer | Compound A | 20000 | 40 |
| | | coating solution (1) | | | |
| Example 3 | 3 | Image recording layer | Compound B | 20000 | 25 |
| | | coating solution (1) | | | |
| Example 4 | 4 | Image recording layer | Compound A | 10000 | 40 |
| | | coating solution (1) | | | |
| Example 5 | 5 | Image recording layer | Compound A | 10000 | 20 |
| | | coating solution (2) | | | |
| Example 6 | 6 | Image recording layer | Compound A | 7000 | 50 |
| | | coating solution (2) | | | |
| Comp. | 7 | Image recording layer | none | 4000 | 40 |
| Example 1 | | coating solution (1) | | | |
| Comp. | 8 | Image recording layer | none | 3000 | 40 |
| Example 2 | | coating solution (2) | | | |
| Comp. | 9 | Image recording layer | none | 3000 | 300 |
| Example 3 | | coating solution (2) | | | |

As apparent from Table 1, the lithographic printing plate precursor having the undercoat layer according to the invention is excellent both in the developability on printing press and printing durability and they can be compatibilized.

### Example 7

Plates with the coating amount for compound A being varied were prepared, the phosphoric intensity for each of the plates was measured by fluorescent X-ray spectrometry to determine a relation between the coating amount of the compound A and the phosphoric intensity based on which a calibration line was prepared.

An undercoat layer coating solution (1) was coated on a support A by using a bar so as to provide a liquid amount of 7.5 ml/m² and then oven-dried at 80° C. for 10 sec to prepare an lithographic printing plate precursor (7). The mass of the compound A present on the lithographic printing plate precursor (7) was measured by using fluorescent X-ray spectrometry which is converted by the calibration line into the amount of compound A, it was 30 mg/m². Then, the lithographic printing plate precursor (7) was immersed in a mixed solvent of water and methanol (mass ratio 1:9) for 10 min and then dried spontaneously. When the mass of the compound A remained on the lithographic printing plate precursor (7) was measured by using fluorescent X-ray spectrometry it was 28 mg/m². Further, when the residual amount as measured by the same method using methyl ethyl ketone instead of the mixed solvent of water and methanol, it was 28 mg/m².

Further, when the weight of the compound A remained on the non-image area of the printing plate of the lithographic printing plate precursor (7) after printing 500 sheets by the printing method described above was measured by using fluorescent X-ray spectrometry, it was 27 mg/m². From the results, it can be seen that the compound A was adsorbed to the support.

### Examples 8 to 10

Lithographic printing plate precursors were prepared in the same procedures as those in Example 1 except for changing the compound A used in the undercoat layer coating solution (1) of Example 1 to compounds shown in the following Table 2 and evaluation was conducted in the same manner as in Example 1. Table 2 shows the result.

TABLE 2

| | | | | Number of |
|---|---|---|---|---|
| | | | | sheet for |
| | | | Number of | development |
| | | | sheet for | on |
| | | Undercoat layer | printing | printing |
| | Image recording layer | compound | durability | press |
| Example 10 | Image recording layer coating | Compound (2) | 30000 | 35 |
| | solution (1) | | | |
| Example 11 | Image recording layer coating | Compound (4) | 35000 | 30 |
| | solution (1) | | | |
| Example 12 | Image recording layer coating | Compound (10) | 30000 | 30 |
| | solution (1) | | | |

### Examples 11 to 13

Lithographic printing plate precursors were prepared in the same procedures as those in Example 5 except for changing the compound A used in the undercoat layer coating solution (1) of Example 5 to compounds shown in the following Table 3 and evaluation was conducted in the same manner as in Example 1. Table 3 shows the result.

TABLE 3

| | | | | Number of |
|---|---|---|---|---|
| | | | | sheet for |
| | | | Number of | development |
| | | | sheet for | on |
| | | Undercoat layer | printing | printing |
| | Image recording layer | compound | durability | press |
| Example 11 | Image recording layer coating | Compound (1) | 12000 | 25 |
| | solution (2) | | | |
| Example 12 | Image recording layer coating | Compound (11) | 10000 | 25 |
| | solution (2) | | | |
| Example 13 | Image recording layer coating | Compound (21) | 15000 | 20 |
| | solution (2) | | | |

### Example 14

(Formation of Image Recording Layer (3))

After coating an undercoat layer coating solution of the following composition on the support prepared in Example 1 by using a bar so as to provide a liquid amount of 7.5 ml/m², it was oven-dried at 80° C. for 10 sec.

Undercoat layer coating solution

| | |
|---|---|
| Water | 15 g |
| Methanol | 135 g |
| Compound A | 0.72 g |

Then, after bar coating an image recording layer coating solution (3) of the following composition on the support coated with the undercoat layer, it was oven-dried at 70° C. for 60 sec and an image recording layer with a dry coating amount of 0.9 g/m² was formed to prepare a lithographic printing plate precursor.

Image recording layer coating solution (3)

| | | |
|---|---|---|
| Water | 40 | g |
| Propylene glycol monomethyl ether | 50 | g |
| Methyl ethyl ketone | 10 | g |
| The following infrared ray absorbing dye (3) | 0.15 | g |
| The following binder polymer (2) with average | 0.5 | g |
| molecular weight 80,000 | | |
| Microcapsule liquid dispersion (as solid content) | 5 | g |
| Polymerization initiator (1) used in Example 1 | 0.5 | g |
| Fluoro surfactant (1) used in Example 1 | 0.1 | g |
| Infrared ray absorbing agent (3) 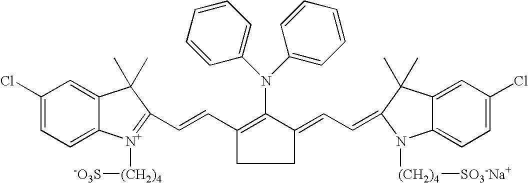 | | |
| Binder polymer (2) 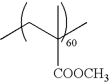 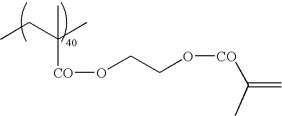 | | |

### Examples 15 to 18

Lithographic printing plate precursors were manufactured in the same procedures as those in Example 14 except for changing the compound A used in the undercoat layer coating solution of Example 14 to compounds shown in the following Table 4.

The same evaluation as that for Example 1 was conducted for lithographic printing plate precursor manufactured in Examples 14 to 18. Table 4 shows the result.

TABLE 4

| | | | | Number of |
|---|---|---|---|---|
| | | | | sheet for |
| | | | Number of | development |
| | | | sheet for | on |
| | | Undercoat layer | printing | printing |
| | Image recording layer | compound | durability | press |
| Example 14 | Image recording layer coating | (A) | 45000 | 20 |
| | solution (3) | | | |
| Example 15 | Image recording layer coating | Compound (1) | 25000 | 15 |
| | solution (3) | | | |
| Example 16 | Image recording layer coating | Compound (5) | 30000 | 20 |
| | solution (3) | | | |
| Example 17 | Image recording layer coating | Compound (15) | 35000 | 20 |
| | solution (3) | | | |
| Example 18 | Image recording layer coating | Compound (26) | 30000 | 20 |
| | solution (3) | | | |

The invention can provide a lithographic printing plate precursor capable of direct plate making by infrared laser scanning and making developability on printing press and contamination durability, and high printing durability, as well as a printing method for lithographic printing plate using the same.

1. A lithographic printing plate precursor comprising:
a support;
an undercoat layer; and
an image recording layer containing a polymerization initiator, a polymerizable compound and an infrared ray absorbing agent, the image recording layer being removable with at least one of a printing ink and a fountain solution,
in this order,
wherein the undercoat layer contains a compound having (a) an ethylenically unsaturated bond and (b) a functional group capable of adsorbing to a surface of the support.

2. A lithographic printing plate precursor comprising:
a support;
an undercoat layer; and
an image recording layer containing a polymerization initiator, a polymerizable compound and an infrared ray absorbing agent, the image recording layer being removable with at least one of a printing ink and a fountain solution,
in this order,
wherein the undercoat layer contains a compound having (a) an ethylenically unsaturated bond and (b) a hydrophilic group.

3. A lithographic printing plate precursor according to claim 1, wherein the compound having (a) the ethylenically unsaturated bond and (b) the functional group capable of adsorbing to the surface of the support further has a hydrophilic group in its molecule.

4. A lithographic printing plate precursor according to claim 1, wherein the compound having (a) the ethylenically unsaturated bond and (b) the functional group capable of adsorbing to the surface of the support is represented by the formula (I): 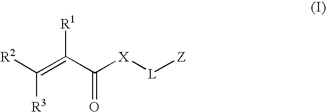
[in which R¹, R² and R³ each represents independently a hydrogen atom, halogen atom, or an alkyl group of 1 to 6 carbon atoms: X represents an oxygen atom or imino; L represents a bivalent connection group; and Z represents a functional group capable of adsorbing to the surface of the support].

5. A lithographic printing plate precursor according to claim 4, wherein L in the formula (I) represents a bivalent connection group containing plural polyoxyalkylene structures.

6. A lithographic printing plate precursor according to claim 1, wherein the support is an aluminum support subjected to a silicate treatment and the functional group capable of adsorbing to the surface of the support is an acid group.

7. A lithographic printing plate precursor according to claim 1, wherein at least one of the infrared ray absorbing agent, the polymerization initiator and the polymerizable compound is microencapsulated.

8. A lithographic printing method comprising:
loading a lithographic printing plate precursor according to claim 1 to a printing press;
imagewise exposing the lithographic printing plate precursor with a laser; and
supplying a printing ink and fountain solution to the lithographic printing plate precursor so as to remove a not-exposed area in the image recording layer by at least one of a printing ink and a fountain solution; and
printing.

9. A lithographic printing method according to claim 8, wherein the loading is performed before the imagewise exposing.

10. A lithographic printing method according to claim 8, wherein the loading is performed after the imagewise exposing.
